(19) United States
(12) Patent Application Publication
(10) Pub. No.: US 2014/0023513 A1
(43) Pub. Date: Jan. 23, 2014

(54) AGGLOMERATED PARTICLE CLOUD NETWORK COATED FIBER BUNDLE

(71) Applicants: Ryan W. Johnson, Moore, SC (US); Xin Li, Boiling Springs, SC (US); Paul J. Wesson, Greenville, SC (US); Padmakumar Puthillath, Greer, SC (US); Philip T. Wilson, Duncan, SC (US)

(72) Inventors: Ryan W. Johnson, Moore, SC (US); Xin Li, Boiling Springs, SC (US); Paul J. Wesson, Greenville, SC (US); Padmakumar Puthillath, Greer, SC (US); Philip T. Wilson, Duncan, SC (US)

(21) Appl. No.: 13/555,257

(22) Filed: Jul. 23, 2012

(51) Int. Cl. F03D 11/00; B32B 5/02; D01F 9/12; D01F 9/08; B32B 9/00

(52) U.S. Cl. 416/230; 428/375; 428/391; 428/367; 428/366

(57) ABSTRACT

An agglomerated particle cloud network coated fiber bundle containing a bundle of fibers and an agglomerated particle cloud network. The bundle of fibers contains a plurality of fibers and void space between the fibers. The agglomerated particle cloud network contains a plurality of agglomerated nanoparticles located in at least a portion of the void space in the bundle of fibers. The agglomerated nanoparticles form bridges between adjacent fibers. Between 10 and 100% by number of fibers contain bridges to one or more adjacent fibers within the agglomerated particle cloud network coated fiber bundle. The agglomerated nanoparticles form between about 1 and 60% of the effective cross-sectional area of the agglomerated particle cloud network coated fiber bundle.

### RELATED APPLICATIONS

This application is related to the following application, which is incorporated by reference: Attorney docket number 6706, filed on Jul. 23, 2012 entitled, “Process for Forming an Agglomerated Particle Cloud Network Coated Fiber Bundle”.

### FIELD OF THE INVENTION

The present invention generally relates to fiber bundles coated with an agglomerated particle cloud network and agglomerated particle cloud network composites.

### BACKGROUND

The use of fiber reinforced composite materials in industry has grown as a way of delivering high strength components with lower weights. Wind turbines have gained increased attention as the quest for renewable energy sources continues. Composites are used extensively in the blades of wind turbines. The quest to generate more energy from wind power has prompted technology advances which allow for increased sizes of wind turbines and new designs of wind turbine components. As the physical size and presence of wind turbines increases, so does the need to balance the cost of manufacturing the wind turbine blades and the performance of the composite materials in the wind blade.

The fatigue performance of fiber reinforced polymer composite materials is a complex phenomenon. In these material systems, fatigue damage is characterized by the initiation of damage at multiple sites, the growth of damage from these origin sites, and the interaction of the damage emanating from multiple origins. This overall process is noteworthy for its distributed nature which offers opportunities to affect the material behavior under cyclic loading.

Fatigue performance of candidate materials has an important role in the design and materials selection process. Material technologies that can enhance the fatigue performance of glass reinforced polymer composites could enable a transition from use of epoxy resin to use of vinyl ester (VE) or unsaturated polyester (UP) resins for high performance utility scale wind turbine blades. The transition from epoxy to VE or UP resins would reduce the resin cost to the wind blade manufacturer, allow use of lower cost molds and enable a significant reduction in mold cycle time through the elimination of complex post-curing processes. The use of textile-based manufacturing processes to build novel microstructural features within the composite may produce this benefit.

### BRIEF SUMMARY

An agglomerated particle cloud network coated fiber bundle contains a bundle of fibers and an agglomerated particle cloud network. The bundle of fibers contains a plurality of fibers and void space between the fibers. The agglomerated particle cloud network contains a plurality of agglomerated nanoparticles located in at least a portion of the void space in the bundle of fibers. The agglomerated nanoparticles form bridges between adjacent fibers. Between 10 and 100% by number of fibers contain bridges to one or more adjacent fibers within the agglomerated particle cloud network coated fiber bundle. The agglomerated nanoparticles form between about 1 and 60% of the effective cross-sectional area of the agglomerated particle cloud network coated fiber bundle.

### BRIEF DESCRIPTION OF THE DRAWINGS

FIG. 1 is cross-sectional illustrative view of one embodiment of an agglomerated particle cloud network coated fiber bundle.

FIG. 2 is a side view SEM of one embodiment of an agglomerated particle cloud network coated fiber bundle.

FIG. 3 is cross-sectional illustrative view of one embodiment of an agglomerated particle cloud network composite.

FIG. 4A is a cross-sectional view SEM of one embodiment of an agglomerated particle cloud network composite.

FIG. 4B is an illustrative version of the SEM of FIG. 4A.

FIG. 5 is cross-sectional view SEM of one embodiment of an agglomerated particle cloud network coated fiber bundle.

FIGS. 6 and 7 are diagrams showing adjacent fibers.

FIG. 8 is an illustrative cross-sectional view illustrating bridging between adjacent fibers.

FIG. 9 is an SEM showing in detail the area between the fibers in the fiber bundle.

FIG. 10 is a illustrative version of the SEM of FIG. 9.

FIG. 11 is an illustrative view of a wind turbine.

FIGS. 12-16 are illustrative views of a turbine blade.

FIG. 17 is a schematic of guide bars for Example 1.

FIG. 18 is a chart showing peak stress to cycles to failure for the some select examples.

FIG. 19 is an SEM of Example 3.

FIG. 20 is an SEM of Example 5.

FIG. 21 is an SEM of Example 7.

FIG. 22 is an SEM of Example 8.

FIG. 23 is an SEM of Example 14.

FIG. 24 is an SEM of Example 15.

FIG. 25 is an SEM of Example 28.

FIG. 26 is an SEM of Example 30.

FIG. 27 is a chart showing average cycles to failure for some examples.

### DETAILED DESCRIPTION

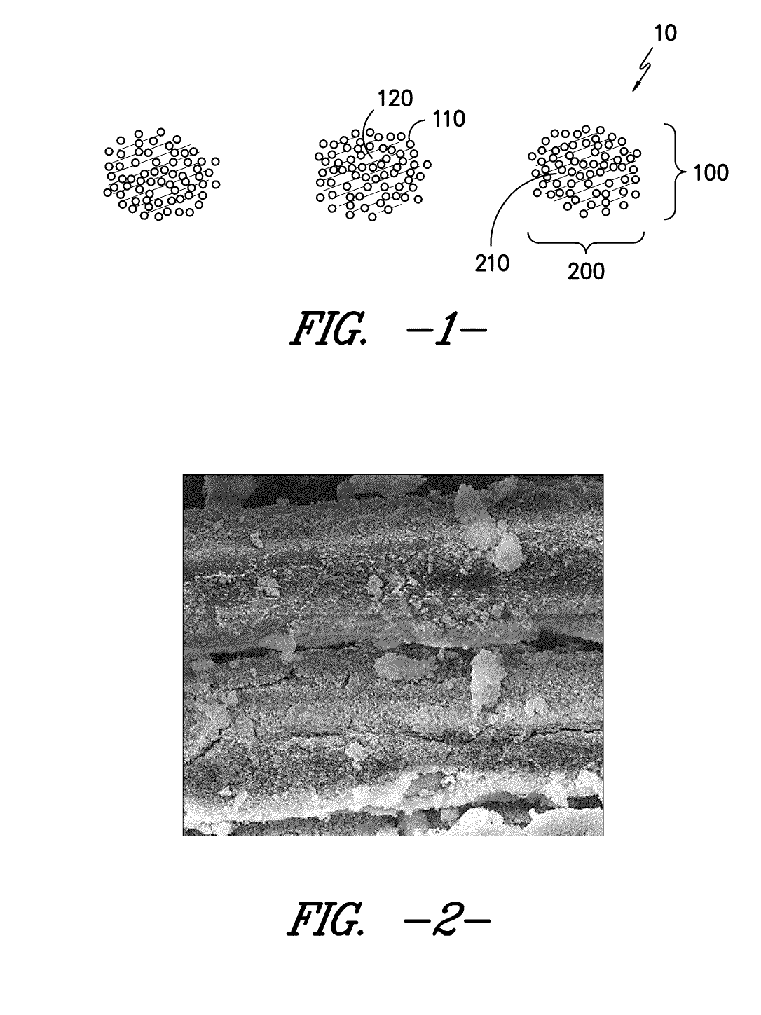

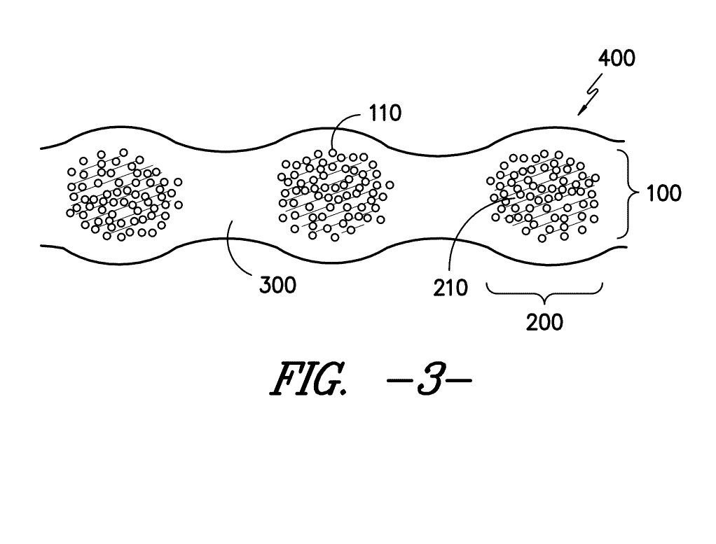

FIG. 1 illustrates one embodiment of an agglomerated particle cloud network coated fiber bundle. The agglomerated particle cloud network coated fiber bundle 10 contains a bundle of fibers 100 and an agglomerated particle cloud network 200. The bundle of fibers contains fibers 110 and void spaces 120. FIG. 2 is a scanning electron microscope (SEM) image taken at 5,000× along the length of the fibers in an agglomerated particle cloud network coated fiber bundle. In FIG. 2, one can see the agglomerated nanoparticles which form the agglomerated particle cloud network and that the agglomerated cloud network is porous.

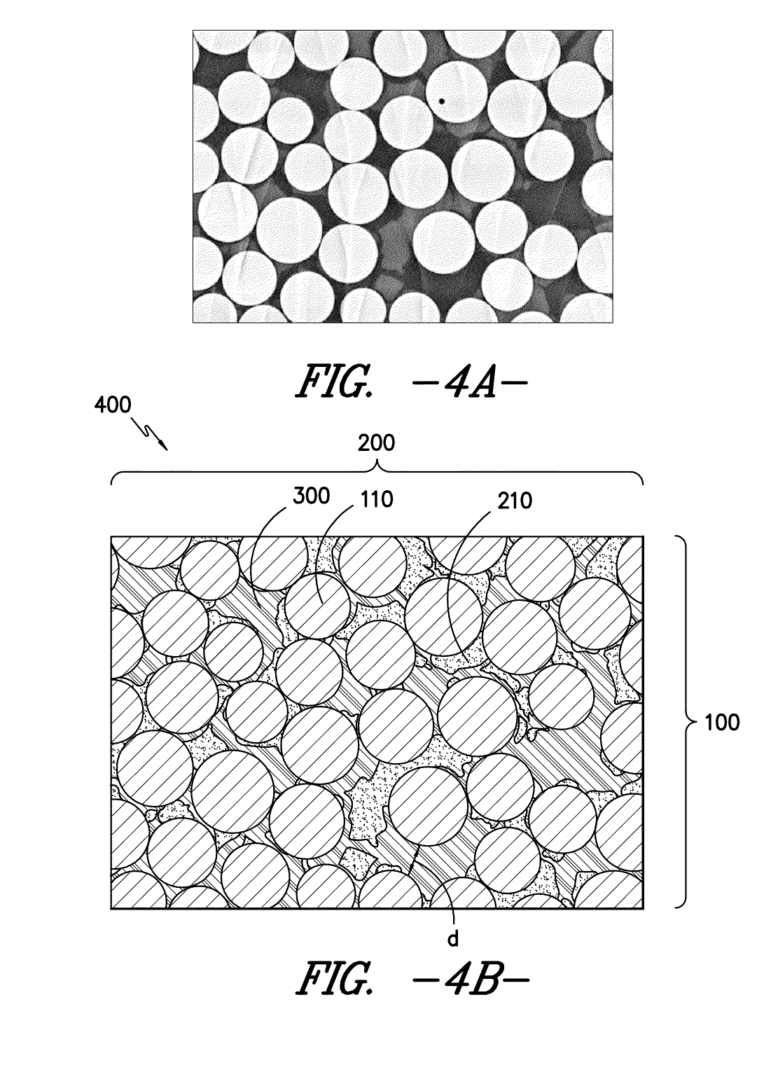

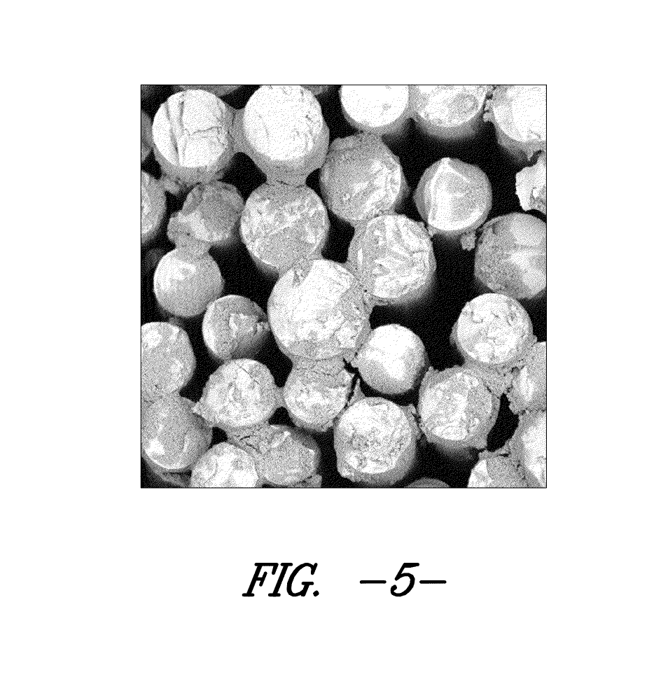

Once the agglomerated particle cloud network coated fiber bundle is infused with resin and cured, an agglomerated particle cloud network composite 400, shown in FIG. 3, is formed. In the agglomerated particle cloud composite, the resin 300 coats and infuses into the bundle of fibers 100 and cures at least partially filling the void spaces 120 in the bundle of fibers 100. FIG. 4A is an SEM image of the agglomerated particle cloud network composite (the same agglomerated particle cloud network coated fiber bundle as FIG. 2 after resin infusion) but at a cross-sectional view at 1000× magnification in back-scattered electrons mode. FIG. 4B is an illustration of the SEM image of FIG. 4A for ease of viewing and labeling. FIG. 4B shows the agglomerated particle cloud network composite 400 containing a bundle of fibers 100, an agglomerated particle cloud network 200, and resin 300. The bundle of fibers 100 contains fibers 110 and resin 300 filling the void spaces. The agglomerated particle cloud network 200 contains agglomerated nanoparticles 210.

The “agglomerated particle cloud network”, in this application, is a collection of nanoparticle agglomerates of varying bulk size and density which are said to form a network due to their interconnected nature. The cloud network is porous meaning that it fills only a portion of the void space between the fibers in the fiber bundles thus allowing composite resin to flow within, among, and around the agglomerates. The agglomerated particle cloud network coated fiber bundle is a combination of fibers, agglomerated particles, and void space. The cloud network will also typically contain some non-agglomerated, or primary, nanoparticles.

The agglomerated cloud network structure is unique from most common coating morphologies. The agglomerated cloud network structure is a three dimensional heterogeneous non-uniform structure hosted within the fiber bundles of the substrate and serves to directly interact with a significantly higher volume fraction of the composite system than traditional unstructured coatings or individual fiber coatings would allow.

Studies have also shown the importance of fiber sizing chemistry to the fatigue performance of composite systems. In certain composite applications, the fiber sizing is applied during fiber manufacture and is intended to remain in place through fabric forming and molding operations. In these cases, the fiber sizing has several well defined functions including protecting the filaments from self-abrasion, lubricating the yarn for further processing, maintaining fiber bundle integrity, promoting fiber separation and wet-out when in contact with the resin, and bonding the fiber surface to the resin. The multifunctional aspect of this type of sizing demands inherent compromises and limitations in formulating the sizing chemistry. Working within these constraints, fiber sizing chemistry can be optimized for particular systems. However, the magnitude of fatigue performance increase measured with optimized fiber sizing has not been found to be sufficient to enable a meaningful shift in resin type (e.g. substitution of unsaturated polyester resin for epoxy resin) for a particular application.

Various previously employed technologies have been shown to improve the fatigue properties of fiber reinforced polymer composites. The type of fibers used in a composite and the properties associated with the fibers often dictate the nature of the fatigue response. Once the type of fiber to be used is defined, the most common approach to improving the fatigue properties of polymer matrix composites has been to improve the toughness of the resin (polymer matrix) itself.

Development of toughness enhanced polymers for use as resins in composites has been a theme in polymer science for decades. Using conventional metrics for neat resin systems, thermoplastics are generally considered tougher than thermosets. However, in high cycle fatigue applications, thermoset systems typically outperform thermoplastic systems due to the differences in crack initiation, crack growth, and crack interaction behavior. Moreover, thermosetting polymers remain the dominant choice in long fiber reinforced composites due to their cost and processing benefits, particularly in large structures.

Due to their use as structural materials in critical applications such as high performance aircraft, numerous material technologies for improving the toughness of thermosetting polymers have been developed. The most ubiquitous approach is to utilize a naturally tough material such as elastomers and combine the tough material with the thermosetting polymer to achieve improved toughness. Improvements on elastomer based concepts employ thermoplastics as the toughening agents which can achieve similar improvements in toughness without compromising the modulus or glass transition temperature of the polymer matrix. In order to work well, these systems require specific chemistry relationships and hence concepts developed in one system such as epoxy are not necessarily compatible with other resin chemistries. For example, systems based on the solubility of the toughening phase in the resin followed by precipitation of the toughening phase into the desired morphology are very sensitive to both resin chemistry and processing conditions.

Some have introduced nanoparticles into a composite by adding the nanoparticles to the resin material which is then infused into the bundles of fibers. In order to work effectively, it is commonly believed that the nanomaterial enhanced resins must be prepared such that the nanomaterials are very well dispersed and remain stable with minimum agglomeration. However, these systems tend to exhibit a characteristic increase in resin viscosity due to the presence of the nanomaterials. When the nanoparticles were added directly into the resin instead of being coated onto the fabric, the resin became very viscous with a paste-like consistency which was unable to be used to impregnate the fabric. Furthermore, the nanomaterials can be filtered by the fibers as the resin fills the reinforcement. This filtering action results in non-uniform distribution of the additive which imparts a non-uniform distribution of composite properties throughout the system.

In order to develop economical approaches to enhancing relevant properties of composite materials, there is a need for targeted material architectures for improving the specific properties of interest using common materials and processes. The current invention leverages the benefits of several approaches to enhancing composite fatigue performance while circumventing some of the detriments of those same approaches. Nanomaterials are assembled into structured coatings within the fiber reinforcement forming a network which helps resist the micro-scale damage initiation and growth mechanisms underlying fatigue failure of composites. This approach builds upon standard reinforcement fabrics and allows the use of standard thermoset resins in standard composite processes.

This system differs from others in that it provides architectures uniquely suited to enhancing the fatigue durability of fiber reinforced polymer composites. The assembly of highly porous nanoparticle agglomerates is an efficient way to influence a large volume of the composite material without a significant mass addition. Deliberate use of nanoparticle agglomerates to form bridges among fibers helps strengthen the fiber-fiber interaction and provides a means of more efficient load sharing. One implication of these alternative load sharing paths is to reduce the critical fiber length enabling a fiber to carry more load over shorter lengths and allowing the system to tolerate a higher number of local failure instances thus increasing the fatigue life. Moreover, the agglomerates locally change the stiffness of the resin which changes the tendency for damage initiation. Once damage occurs, the agglomerates mitigate the ability for damage to interact and therefore significantly delay the onset of reductions in material strength under cyclic loading conditions.

Within the agglomerated particle cloud network coated fiber bundle, the agglomerated nanoparticles form bridges. FIG. 5 shows a SEM image of a cross-section of agglomerated particle cloud network bundle of fibers. One can see the bridges between adjacent fibers. Preferably, between about 10 and 100% by number of fibers contain bridges to one or more adjacent fibers within the agglomerated particle cloud network coated fiber bundle. In another embodiment, between about 50 and 100% by number of fibers contain bridges to one or more adjacent fibers within the agglomerated particle cloud network coated fiber bundle, more preferably between about 60 and 100%, more preferably between about 75 and 100% by number. The percentage of bridging may be calculated by taking a typical cross-section of the coated bundle of fibers, determining the number of fibers that are connected to at least one of their adjacent fibers by agglomerated particles divided by the total number of fibers. This bridging is formed by the agglomerated nanoparticles, which extend between two adjacent fibers.

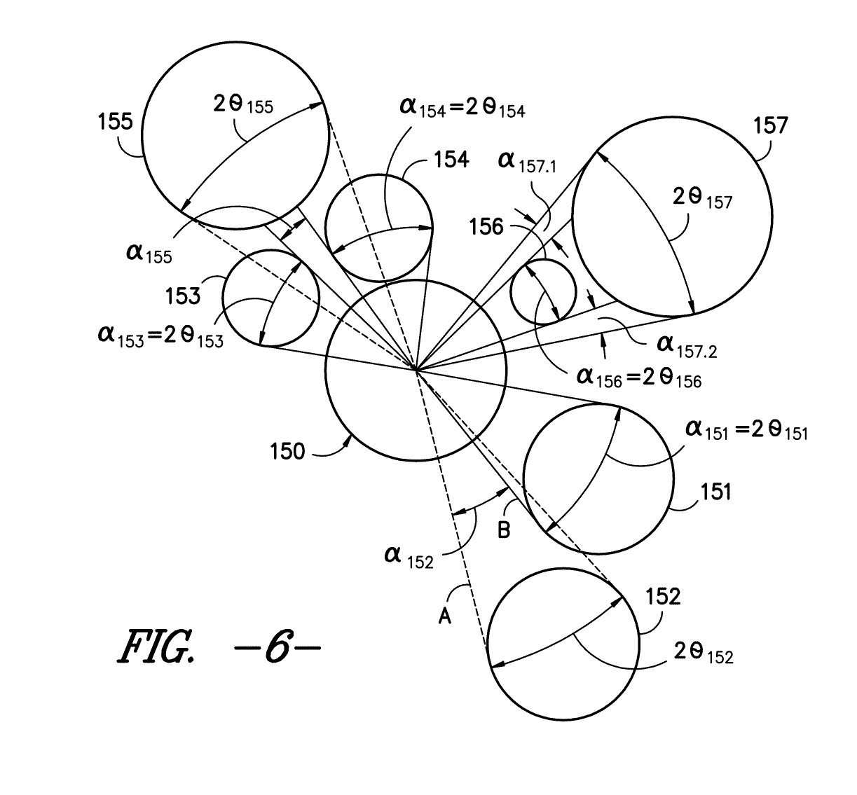

From a cross sectional view of a fiber bundle containing an agglomerated particle cloud network the adjacent fibers are defined using the following method. Starting from the center of a specific fiber, all fibers whose centers are within 10 average fiber diameters with a significant line of sight from the center of the specified fiber are considered adjacent. A significant line of sight means that at least half of the possibly adjacent fiber is visible from the center of the specified fiber and is not covered by parts of other fibers that are closer to the specified fiber than the possibly adjacent fiber. Examples of this are shown in FIG. 6 where fiber 150 is the specified fiber. In this FIG. 6, solid tangent lines from the center of fiber 150 are drawn to fibers 151, 153, 154, and 156 and represent areas that those fibers block the view of additional fibers from the center of fiber 150, while dashed tangent lines are drawn to fibers 152, 155, and 157 to represent the full size of fibers that have a partially blocked view of fiber 150. From the center of fiber 150, all of fibers 151, 153, 154, and 156 are visible, so they are considered adjacent to fiber 150. Fiber 152 is also adjacent to fiber 150 as more than half of its surface is visible from the center of fiber 150, even though part of it is blocked by fiber 151. Fiber 155 is not adjacent to fiber 150, as more than half of its view is blocked by fibers 153 and 154. Finally fiber 157 is not adjacent to fiber 150 as more than half of its view is blocked by fiber 156.

The determination of a significant line of sight can be done either by making a geometric measurement from a cross sectional image of a fiber bundle or by doing a calculation. For example, the geometric measurement can be done on fibers 153 and 154 by first drawing lines from the center of fiber 150 that are tangent to both sides of each fiber. The angle formed by the lines that are tangent to fiber 155 defines its size (which is 2 θ₁₅₅), while the visible portion is determined by the angle α₁₅₅ between the tangent lines on fibers 153 and 154. Since α₁₅₅<θ₁₅₅, fiber 155 is not adjacent to fiber 150. Similarly, tangent lines can be drawn to fibers 151 and 152. The amount of fiber 152 that is visible is then given by the angle α₁₅₂ between the tangent line A to fiber 152 and tangent line B to fiber 151. Since α₁₅₂>θ₁₅₂, fiber 152 is adjacent to fiber 150.

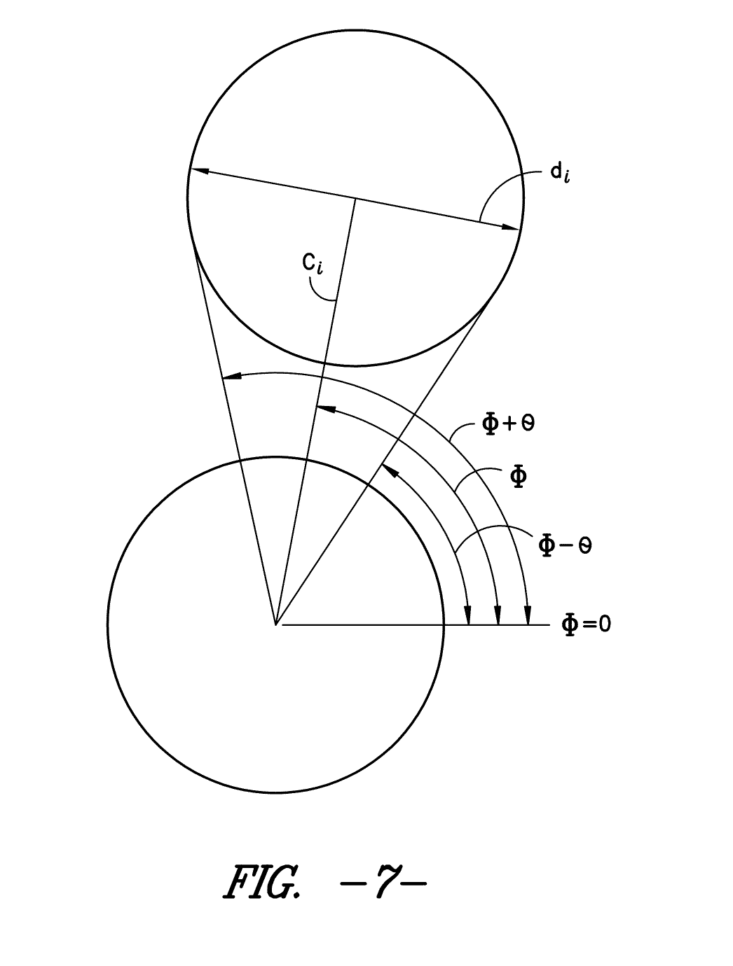

These measurements can also be done mathematically if the fibers are assumed to be cylindrical. Using polar coordinates, the position of each fiber with a diameter of dᵢ that may be adjacent to the specified fiber can be defined by a distance cᵢ between the center of the specified fiber and the center of fiber i and an angle φᵢ between the line connecting the center of the specified fiber and the center of fiber i and a reference line passing through the center of the specified fiber (see FIG. 7). The size of each fiber may then be determined as θᵢ=sin⁻¹ (dᵢ/2 cᵢ), and it blocks the region around the specified fiber from φᵢ−θᵢ to φᵢ+θᵢ. Considering the fibers in order of increasing cᵢ, the visible portion of each fiber may block a new region around the specified fiber that covers some angle αᵢ. Note that in the case of a fiber that is eclipsed by another fiber, the region may be disconnected (fibers 156 and 157), and its size measured as a sum of the angles defining the size of the individual parts. After all fibers have been considered where cᵢ is less than or equal to 10 times the average fiber diameter, only those fibers where αᵢ>θᵢ are adjacent to the specified fiber.

This bridging between fibers helps to control the relative position of the fibers. These bridges may or may not be adhered to the surface of the fibers 110. An agglomerate that extends between the two adjacent fibers 110 but is not attached two both fibers 110 still forms a bridge as defined in this application. Preferably, the bridges between two (or more than 2) adjacent fibers 110 are adhered to at least one of the fibers 110, more preferably adhered to both (or all) of the fibers 110. The bridging increases the interaction between fibers, prevents compression of the space between fibers, and still allows resin to flow between and around the agglomerated particle and fibers. Inter-fiber bridging also changes the way cracks initiate, propagate, and interact within the composites. Bridging may be seen in the schematic drawing of FIG. 4B.

Where agglomerated nanoparticle bridging occurs in the bundle of fibers 100 depends on a number of factors including but not limited to the type of nanoparticle, solvent, surface chemistry of fiber, separation distance between adjacent fibers, coating process conditions, drying conditions, post mechanical treatment during and after drying. One factor is the separation distance “d” between adjacent fibers. It has been shown that there is a greater tendency towards bridging to occur when the separation distance “d” between two adjacent fibers is less than about the average diameter of the fibers 110. There are some important factors that control the bridge forming dynamics including capillary forces, nanoparticle-nanoparticle interactions, nanoparticle-fiber interactions, nanoparticle-solvent interactions and solvent-fiber interactions. The latter interactions help determine if the agglomerates form, what configuration the agglomerates take, and where the agglomerates are deposited. It is believed that when the separation distance “d” between two adjacent fibers is much larger than the average diameter of the fibers, the capillary force may not be strong enough to keep the bridging structure stable during drying. The type of nanoparticle, solvent, or surface chemistry of the fiber may change nanoparticle and nanoparticle solution attraction to fiber, and therefore affect the coating structure. The coating process conditions can affect the space between fibers, the distribution of nanoparticles in the bundle of fibers, and the wet pickup during coating. The drying conditions affect the solvent evaporation speed and the amount of solvent that can be removed from the bundle of fibers. An appropriate drying rate must be employed to form agglomerated particle bridging among fibers instead of strictly forming a fiber surface coating. Post mechanical treatment may affect the space between fibers, the quantity of bridging in the bundle of fibers, and the agglomerated particle size.

Referring to FIG. 8, all fibers with a “X” mark are considered to have bridge to adjacent fibers by definition described above. In FIG. 8, 38 fibers have the “X” mark and the total number of fibers is 43, therefore 88% by number of fibers contain bridges to one or more adjacent fibers within the agglomerated particle cloud network coated fiber bundle by definition.

The agglomerated nanoparticles form between about 1 and 60% of the effective cross-sectional area of the agglomerated particle cloud network coated fiber bundle. In another embodiment, the agglomerated nanoparticles form between about 5 and 50% of the effective cross-sectional area of the agglomerated particle cloud network coated fiber bundle, more preferably between about 10% and 45%, more preferably between about 15% and 40%. “Effective cross-sectional area”, in this application, is measured by taking a cross-sectional image of the fiber bundle and calculating the apparent area of the agglomerated nanoparticles. Because the agglomerated nanoparticles have a low bulk density and high porosity, the effective area of the agglomerated particles is large compared to the amount (summed weight or summed volume) of nanoparticles in the cloud network coated fiber bundles. If the effective cross-sectional area of agglomerated particle is less than about 1%, there may not be enough agglomerated particles to form the bridging structure required for the cloud network in the fiber bundle. If the effective cross-sectional area of agglomerated particle is larger than about 60%, there may not be enough porosity in the cloud network for resin infusion leading to lower performance due to dry spots or voids in the composite system.

One method to measure the effective cross-sectional area of the agglomerates is by utilizing an SEM image of a typical cross section in the agglomerated particle cloud network composite. From a highly magnified image of a typical cross section, one can see that the agglomerate is a porous structure containing many agglomerated nanoparticles. Because of this porosity, the area covered by individual nanoparticles is not a good measure for the effective area of the agglomerate. Instead, the area of the agglomerated particles includes not only the area of the nanoparticles forming the agglomerate but also the area of the pores or resin that is enclosed within the outer boundary of the agglomerate.

One method of identifying the outer surface of the agglomerate is using scanning electron microscopy at a magnification between 200×-5000× in the back-scattered electrons (BSE) mode, where the fibers will have a consistent shade intensity, the resin another, and the agglomerates may have a third shade intensity and may have a distinct pattern. The external edge of the effective area is then defined by a change in the image intensity from either agglomerate to fiber or agglomerate to resin. In the case that this edge is a gradual transition, threshold shade intensity can be used to consistently define a line for each image. The area of the agglomerate can then be obtained by measuring the area enclosed by the outer boundary. If the agglomerate has large holes or cracks within the external boundary, the cracks or holes can be traced around and their area subtracted from the area enclosed by the external border. The total area for all agglomerates is then divided by the area of the fibers in the image to give a percentage. A non-limiting group of other imaging methods could be used to identify these surfaces including: light microscopy, transmission electron microscopy, atomic force microscopy, magnetic resonance imaging or computed tomography scanning.

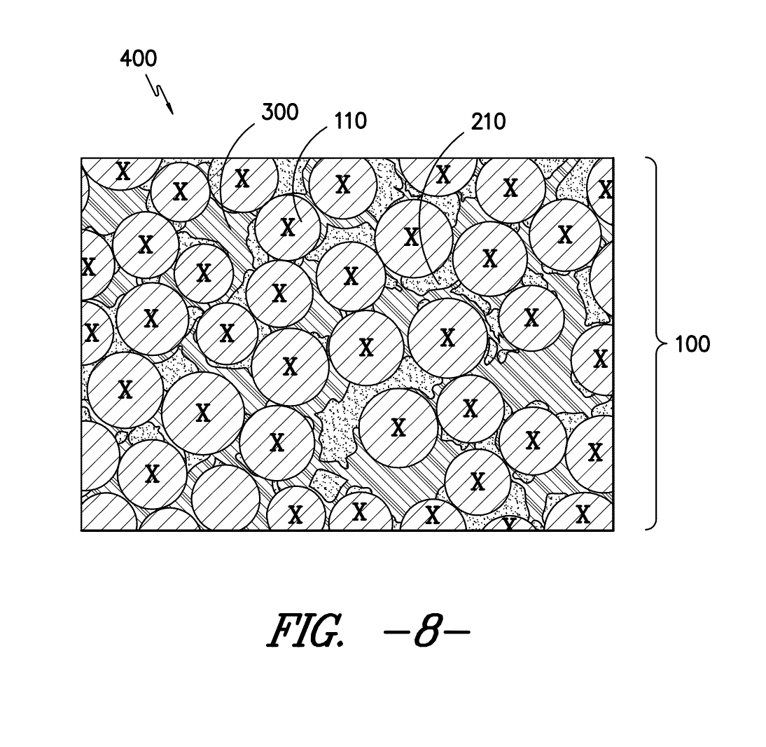

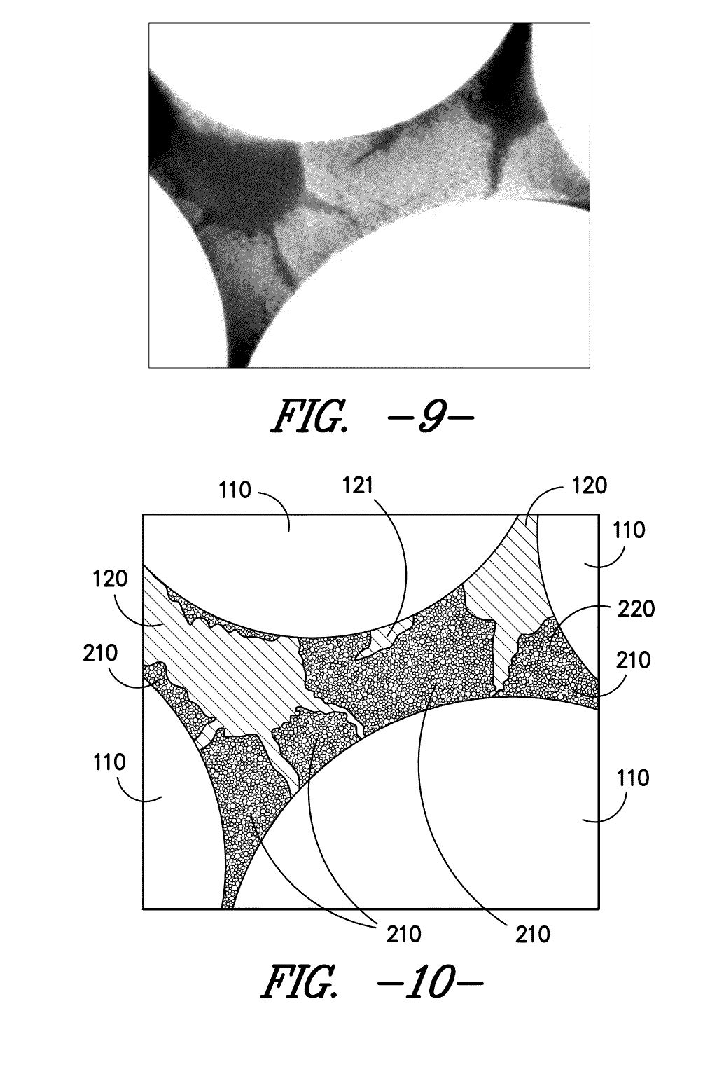

The SEM in FIG. 9 of a agglomerated particle cloud network composite has been redrawn in FIG. 10 to highlight the external edges between agglomerated nanoparticle and resin or fibers. In FIG. 10, the agglomerated nanoparticles 210 have edges defined by the fibers 110 and resin 300. The agglomerated nanoparticles 210 contain individual nanoparticles 220 (sized not to scale). The resin 300 fills an area of a crack in the nanoparticle agglomerate 210. The total area of nanoparticles 210 can then be divided by the total area of the Figure to obtain the effective cross sectional area of the agglomerates relative to a small sample of the bundle. In a typical measurement, 100 or more fibers and their interstitial spaces should be included in the SEM to produce a more representative measurement relative to the bulk average.

For example, FIG. 4B is converted from FIG. 4A by using this method. The percentage of effective area of agglomerated particles to the fiber bundle can be calculated by using image analysis software such as Adobe Photoshop, MATLAB Image Processing Toolbox, or Image-Pro to count the number of pixels in the agglomerated particle area divided by total number of pixels in the image. The percentage of effective area of agglomerated particles to the fibers can be calculated by using image analysis software such as Adobe Photoshop, MATLAB Image Processing Toolbox, or Image-Pro to count the number of pixels in the agglomerated particle area divided by total number of pixels in the fiber region. Based on this method, the effective area of agglomerated particles to the whole fiber bundle is 15.7%. The effective area of agglomerated particles to the fibers is 24.2%.

Typically, measurements of the bundle of fibers are taken after infusion because cutting a bundle of fibers may produce a large amount of debris which can make identifying the bridges difficult. Moreover, during SEM, the fibers and bridges may develop an electrostatic potential, possibly causing them to move and making imaging significantly more difficult. Finally, it is difficult to obtain a straight and perpendicular cut through the fiber bundle in order to have a flat cross section to measure. It believed that the cloud structure in the agglomerated particle cloud network coated fiber bundle is substantially the same as the cloud structure in the agglomerated particle cloud network composite. The reasons behind this belief include 1) the flow velocity of resin in the fiber bundles is driven by capillary forces and hence is low, so there is little chance of bridges getting washed away or moved, 2) bridges are adhered to the surface of the fibers (i.e. typically cannot be washed off), 3) bridges form to the contour of the fibers, thus, if the fibers twist in the bundle and the space between fibers changes shape the solid agglomerates will not be able to push through the tortuous path (they could possibly slide down the center of an ordered array of fibers) so they have limited mobility within the bundle 4) the size of the bridges is large relative to the separation distance between fibers, so they will have trouble getting out of a fiber bundle, 5) experiments showed that the shape of agglomerated particles doesn't change after it is immersed in resin in the time scale of resin curing time. This suggests that the agglomerated particles are not able to be dissolved or re-dispersed in resin.

Agglomerated particle cloud network coated fiber bundles may be measured before infusion if they are held in place, for instance by pulling out a single tow from a fabric then wrapping it in heat shrink tubing and shrinking the tubing before cleaving it to image a cross section. FIG. 5 shows an SEM image taken by this method. One can see the bridging structure between adjacent fibers before resin infusion. While this provides a better image, it does not yield a flat surface that can be used for quantification.

While the agglomerated particle cloud network 200 may cover between about 3 and 100% of the surface area of the fibers 110, the agglomerated nanoparticles are discontinuous on the surface. This means that while the fibers may have a thin coating of non-agglomerated nanoparticles, binders, and other coating additives, the agglomerated nanoparticles do not cover the surface of the fibers completely. In one embodiment, the agglomerated nanoparticles cover between about 3% and 99% of the circumferential area of the fibers and between about 3% and 99% along a line down the longitudinal direction of the fibers.

The bundle of fibers 100 may be any suitable bundle of fibers for the end product. The composite may contain a single bundle of fibers or the bundle of fibers may be in a textile layer including but not limited to a woven textile, non-woven textile (such as a chopped strand mat), bonded textile, knit textile, a unidirectional textile, and a sheet of strands. In one embodiment, the bundle of fibers 100 are formed into unidirectional strands such as rovings and may be held together by bonding, knitting a securing yarn across the rovings, or weaving a securing yarn across the rovings. In the case of woven, knit, warp knit/weft insertion, non-woven, or bonded the textile can have fibers that are disposed in a multi- (bi- or tri- or quadri-) axial direction. In one embodiment, the bundle of fibers contains an average of at least about 2 fibers, more preferably at least about 20 fibers. The fibers 110 within the bundles of fibers 100 generally are aligned and parallel, meaning that the axes along the lengths of the fibers 110 are generally aligned and parallel.

In one embodiment, the textile is a woven textile, for example, plain, satin, twill, basket-weave, poplin, jacquard, and crepe weave textiles. A plain weave textile has been shown to have good abrasion and wear characteristics. A twill weave has been shown to have good properties for compound curves.

In another embodiment, the textile is a knit textile, for example a circular knit, reverse plaited circular knit, double knit, single jersey knit, two-end fleece knit, three-end fleece knit, terry knit or double loop knit, weft inserted warp knit, warp knit, and warp knit with or without a micro-denier face.

In another embodiment, the textile is a multi-axial textile, such as a tri-axial textile (knit, woven, or non-woven). In another embodiment, the textile is a non-woven textile. The term non-woven refers to structures incorporating a mass of fibers that are entangled and/or heat fused so as to provide a structure with a degree of internal coherency. Non-woven textiles may be formed from many processes such as for example, meltspun processes, hydroentangeling processes, mechanically entangled processes, stitch-bonded, wet-laid, and the like.

In another preferred embodiment, the textile is a unidirectional textile and may have overlapping fiber bundles or may have gaps between the fiber bundles.

In one embodiment, the bundles of fibers 100 are in a multi-axial knit textile. A multi-axial knit has high modulus, non-crimp fibers that can be oriented to suit a combination of property requirements and may create three dimensional structures. In another embodiment, the bundles of fibers 100 are in a single roving as in filament winding.

The bundles of fibers 100 contain fibers 110 which may be any suitable fiber for the end use. “Fiber” used herein is defined as an elongated body and includes yarns, tape elements, and the like. The fiber may have any suitable cross-section such as circular, multi-lobal, square or rectangular (tape), and oval. The fibers may be monofilament or multifilament, staple or continuous, or a mixture thereof. Preferably, the fibers have a circular cross-section which due to packing limitations intrinsically provides the void space needed to host the agglomerated particle cloud network. A circular cross-section can provide enough void space for the agglomerated particle cloud network. Preferably, the fibers 110 have an average length of at least about 3 millimeters. In another embodiment, the fiber length is at least about 100 times the fiber diameter. In another embodiment, the average fiber length is at least about 10 centimeters. In another embodiment, the average fiber length is at least about 1 meter. The fiber lengths can be sampled from a normal distribution or from a bi-, tri- or multi-modal distribution depending on how the fiber bundles and fabrics are constructed. The average lengths of fibers in each mode of the distribution can be selected from any of the fiber length ranges given in the above embodiments.

The fibers 110 can be formed from any type of fiberizable material known to those skilled in the art including fiberizable inorganic materials, fiberizable organic materials and mixtures of any of the foregoing. The inorganic and organic materials can be either man-made or naturally occurring materials. One skilled in the art will appreciate that the fiberizable inorganic and organic materials can also be polymeric materials. As used herein, the term “polymeric material” means a material formed from macromolecules composed of long chains of atoms that are linked together and that can become entangled in solution or in the solid state. As used herein, the term “fiberizable” means a material capable of being formed into a generally continuous or staple filament, fiber, strand or yarn. In one embodiment, the fibers 110 are selected from the group consisting of carbon, glass, aramid, boron, polyalkylene, quartz, polybenzimidazole, polyetheretherketone, basalt, polyphenylene sulfide, poly p-phenylene benzobisoaxazole, silicon carbide, phenolformaldehyde, phthalate and napthenoate, polyethylene. In another embodiment, the fibers are metal fibers such as steel, aluminum, or copper.

Preferably, the fibers 110 are formed from an inorganic, fiberizable glass material. Fiberizable glass materials useful in the present invention include but are not limited to those prepared from fiberizable glass compositions such as S glass, S2 glass, E glass, R glass, H glass, A glass, AR glass, C glass, D glass, ECR glass, glass filament, staple glass, T glass and zirconium oxide glass, and E-glass derivatives. As used herein, “E-glass derivatives” means glass compositions that include minor amounts of fluorine and/or boron and most preferably are fluorine-free and/or boron-free. Furthermore, as used herein, “minor amounts of fluorine” means less than 0.5 weight percent fluorine, preferably less than 0.1 weight percent fluorine, and “minor amounts of boron” means less than 5 weight percent boron, preferably less than 2 weight percent boron. Basalt and mineral wool are examples of other fiberizable glass materials useful in the present invention. Preferred glass fibers are formed from E-glass or E-glass derivatives.

The glass fibers of the present invention can be formed in any suitable method known in the art, for forming glass fibers. For example, glass fibers can be formed in a direct-melt fiber forming operation or in an indirect, or marble-melt, fiber forming operation. In a direct-melt fiber forming operation, raw materials are combined, melted and homogenized in a glass melting furnace. The molten glass moves from the furnace to a forehearth and into fiber forming apparatuses where the molten glass is attenuated into continuous glass fibers. In a marble-melt glass forming operation, pieces or marbles of glass having the final desired glass composition are preformed and fed into a bushing where they are melted and attenuated into continuous glass fibers. If a pre-melter is used, the marbles are fed first into the pre-melter, melted, and then the melted glass is fed into a fiber forming apparatus where the glass is attenuated to form continuous fibers. In the present invention, the glass fibers are preferably formed by the direct-melt fiber forming operation.

In one embodiment, when the fibers 110 are glass fibers, the fibers contain a sizing. This sizing may help processability of the glass fibers into textile layers and also helps to enhance fiber—polymer matrix interaction. In another embodiment, the fibers 110 being glass fibers do not contain a sizing. The non-sizing surface may help to simplify the coating process and give better control of particle—fiber interaction and particle agglomeration. Fiberglass fibers typically have diameters in the range of between about 10-35 microns and more typically 17-19 microns. Carbon fibers typically have diameters in the range of between about 5-10 microns and typically 7 microns, the fibers (fiberglass and carbon) are not limited to these ranges.

Non-limiting examples of suitable non-glass fiberizable inorganic materials include ceramic materials such as silicon carbide, carbon, graphite, mullite, basalt, aluminum oxide and piezoelectric ceramic materials. Non-limiting examples of suitable fiberizable organic materials include cotton, cellulose, natural rubber, flax, ramie, hemp, sisal and wool. Non-limiting examples of suitable fiberizable organic polymeric materials include those formed from polyamides (such as nylon and aramids), thermoplastic polyesters (such as polyethylene terephthalate and polybutylene terephthalate), acrylics (such as polyacrylonitriles), polyolefins, polyurethanes and vinyl polymers (such as polyvinyl alcohol).

In one embodiment, the fibers 110 preferably have a high strength to weight ratio. Preferably, the fibers 110 have strength to weight ratio of at least 0.7 GPa/g/cm³ as measured by standard fiber properties at 23° C. and a modulus of at least 69 GPa.

The separation distance between the fibers 110 within the bundle of fibers 100 is represented by “d” on FIG. 4B. As one can see in FIG. 4B, there are a range of separation distances d between adjacent fibers. These separation distances d may be little to none, less than the average diameter of the fibers, greater than the average diameter of the fibers to 4 times the diameter of the fibers, or greater than 4 times the average diameter of the fibers. This separation distance d along with the properties of the agglomerated particle cloud network affects the performance of the final product.

The agglomerated nanoparticles particle cloud network 200 contains agglomerated nanoparticles 210. These agglomerated nanoparticles 210 contain nanoparticles 220 which each may be any suitable composition and formation for the desired end product and are shown in FIG. 10. “Agglomerated nanoparticles”, in this application, means a plurality of nanoparticles adhered to one another that do not separate through regular mixing or dispersion techniques and are sometimes referred herein as agglomerates. The agglomerated nanoparticles 210 typically comprise at least 10 nanoparticles adhered together. In one embodiment, the agglomerated nanoparticles 210 have at least one dimension between about 1 to 100 microns. In another embodiment, the agglomerated nanoparticles 210 preferably have at least one dimension of between 0.25 and 4 times the average fiber diameter.

The nanoparticles 220 may be any suitable nanoparticle including but not limited to silica, fumed silica, alumina, carbon nanotubes, polymeric material, and mixtures thereof. “Nanoparticle”, in this application is defined to mean particles having at least one dimension less than one micron.

The nanoparticles 220 may have a median particle diameter less than one micron. Preferably, the nanoparticles 220 have a median particle diameter less than 0.2 micron. The smaller particle diameter helps the particles to penetrate into fiber bundles. The nanoparticle may have any suitable shape including but not limited to sphere, needle, disc, or amorphous shape. In one embodiment, the nanoparticles may contain a surface treatment. The nanoparticle may have surface treatment, including but not limited to a coupling agent, grafted oligomers or polymers, or surface charge modifiers. The surface treatments can be chosen so as to help the nanoparticles disperse in a solvent, remain dispersed in a solvent, build a desirable agglomerated nanoparticle network structure during drying, or provide better adhesion between the particles and the resin or the fibers.

In one embodiment, the nanoparticles 220 comprise fumed silica. The shape of individual fumed silica nanoparticles is typically spherical with a median diameter less than 0.2 micron. In one embodiment, the fumed silica comprises a surface treatment. The surface treatment helps fumed silica to disperse in water and to form agglomerated structures during drying. The surface treatment may also help to build a stronger interface between particles and resin in the composite. In one embodiment, the surface treatment on the fumed silica is a cationic surface treatment. This cationic fumed silica has been observed to yield a consistent coating on glass fibers.

The agglomerated nanoparticles 210 are found both in the void space 120 and on the surface of the fibers 110 of the bundle of fibers 100. In one embodiment, the average size of the agglomerated nanoparticles 210 is between about 0.25 and 4 times the average separation distance of adjacent fibers 110. This is calculated by measuring the fiber diameters and agglomerated nanoparticles within a defined area imaged by SEM. The average size of the agglomerated nanoparticles is the average size of the agglomerate, not of the individual nanoparticles making up the agglomerate. A conservative estimate of the size of a nanoparticle agglomerate can be estimated by measuring the area A of the agglomerate then calculating the diameter of a circle with the same area as l=(4A/π)^{1/2}.

Textiles or other assemblies of the agglomerated particle cloud network coated fiber bundle can be further processed to create composite preforms. One example would be to wrap the fiber bundles around foam strips or other shapes to create three dimensional structures. These intermediate structures can then be formed into composite structures by the addition of resin in at least a portion of the void space in the fiber bundle.

The agglomerated particle cloud network coated fiber bundle can be further processed into an agglomerated particle cloud network composite as shown in FIG. 3 with the addition of resin in at least a portion of the void space in the fiber bundle.

The agglomerated particle cloud network coated fiber bundle 10 is impregnated or infused with a resin 300 which flows, preferably under differential pressure, through the coated fiber bundle 10 at least partially filling the void space creating the agglomerated particle cloud network composite 400. The agglomerated particle cloud network composite could also be created by other wetting or composite laminating processes including but not limited to hand lay-up, filament winding, and pultrusion. Preferably, the resin flows throughout the coated bundle of fibers 10 (and all of the other reinforcing materials such as reinforcing sheets, skins, optional stabilizing layers, and strips) and cures to form a rigid, composite 400.

It is within the scope of the present invention to use either of two general types of hardenable resin to infuse or impregnate the porous and fibrous reinforcements of the cores and skins. Thermoset resins, such as unsaturated polyester, vinyl ester, epoxy, polyurethane, acrylic resin, and phenolic, are liquid resins which harden by a process of chemical curing, or cross-linking, which takes place during the molding process. Thermoplastic resins, such as polyethylene, polypropylene, PET and PEEK, are liquefied by the application of heat prior to infusing the reinforcements and re-harden as they cool within the panel. In one embodiment, the resin 300 is an unsaturated polyester, a vinylester, an epoxy resin, a bismaleimide resin, a phenol resin, a melamine resin, a silicone resin, or thermoplastic PBT or Nylon or mixtures thereof. Unsaturated polyester is preferred due to its moderate cost, good mechanical properties, good working time, and cure characteristics.

In some commercial applications, the epoxy based resins have higher performance (fatigue, tensile strength and strain at failure) than polyester based resins, but also have a higher cost. The addition of the cloud network to the bundle of fibers increases the performance of a composite using an unsaturated polyester resin to levels similar to the performance levels of the epoxy resin composite, but with a lower cost than the epoxy resin system.

Having the resin 300 flow throughout the coated fiber bundle 10 under differential pressure may be accomplished by processes such as vacuum bag molding, resin transfer molding or vacuum assisted resin transfer molding (VARTM). In VARTM molding, the components of the composite are sealed in an airtight mold commonly having one flexible mold face, and air is evacuated from the mold, which applies atmospheric pressure through the flexible face to conform the composite 400 to the mold. Catalyzed resin is drawn by the vacuum into the mold, generally through a resin distribution medium or network of channels provided on the surface of the panel, and is allowed to cure. Additional fibers or layers such as surface flow media can also be added to the composite to help facilitate the infusion of resin. A series of thick yarns such as heavy rovings or monofilaments can be spaced equally apart in one or more axis of the reinforcement to tune the resin infusion rate of the composite.

As an alternate to infusion of the coated bundle of fibers 10 with liquid resin, the coated bundle of fibers may be further pre-impregnated (prepregged) with partially cured thermoset resins, thermoplastic resins, or intermingled with thermoplastic fibers which are subsequently cured by the application of heat.

The agglomerated particle cloud network composite 400 may be used as a structure or the composite 400 have additional processes performed to it or have additional elements added to form it into a structure. It may also be bonded to other materials to create a structure including incorporation into a sandwich panel. In one embodiment, skin sheet materials such as steel, aluminum, plywood or fiberglass reinforced polymer may be added to a surface of the composite 400. This may be achieved by adding the additional reinforcement layers while the resin cures or by adhesives. Examples of structures the composite may be (or be part of) include but are not limited to wind turbine blades, boat hulls and decks, rail cars, bridge decks, pipe, tanks, reinforced truck floors, pilings, fenders, docks, reinforced beams, retrofitted concrete structures, aircraft structures, reinforced extrusions or injection moldings or other like structural parts.

The agglomerated particle cloud network composite 400, as compared to a composite without the agglomerated particle cloud network, typically has increased local stiffness, increased local toughness, longer crack path length, and more uniform fiber distribution with the bundles. The composites having the agglomerated particle cloud network also may have enhanced fatigue, enhanced resistance to delamination, enhanced impact damage tolerance. These benefits may allow for longer, lighter, more durable and/or lower cost structures in numerous applications including wind turbine blades.

One benefit of fiber bundles enhanced with agglomerated particle cloud networks is the opportunity to utilize the enhanced fiber bundles in specific subsections of the structure where the demonstrated performance benefit is most applicable.

Wind turbine blades are an example of a large composite structure that can benefit from use of an agglomerated particle cloud network in specific areas. The loading patterns on wind turbine blades are complex, and the structure is designed to satisfy a range of load requirements. For example, wind turbine blades are designed using at least four different design criteria. The blade must be stiff enough to not strike the turbine tower, strong enough to withstand the maximum expected wind gust loads, durable enough to tolerate hundreds of millions of cycles due to the rotation of the generator, and sufficiently resistant to buckling to avoid collapsing when flexed under the combined stress induced the blade itself and the wind loads.

FIG. 11 is a schematic of a wind turbine 700 which contains a tower 702, a nacelle 704 connected to the top of the tower, and a rotor 706 attached to the nacelle. The rotor contains a rotating hub 708 protruding from one side of the nacelle, and wind turbine blades 710 attached to the rotating hub.

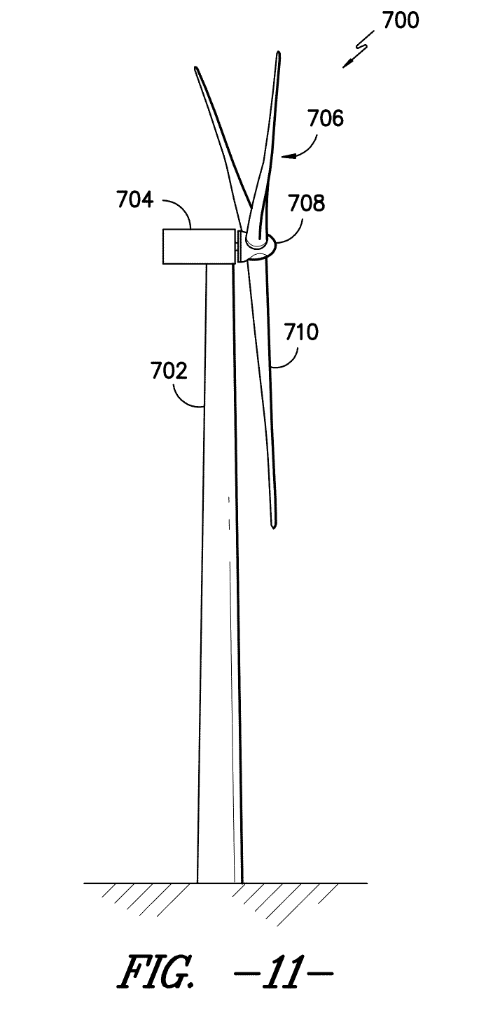

FIG. 12 is a schematic of a wind turbine blade 710. The blade represents a type of airfoil for converting wind into mechanical motion. The airfoil 800 extends from a root section 802 at one end along a longitudinal axis to the tip section 804 at the opposing end.

Sectional view A-A in FIG. 13 from FIG. 12 shows a typical blade cross section and identifies four functional regions around the perimeter of the wind turbine blade air foil. The leading edge 806 and trailing edge 808 are the regions at the ends of the line extending along the maximum chord width W. The leading and trailing edge regions are connected by two portions of a blade shell, a suction side shell 810 and a pressure side shell 812. The blade shells are connected via a shear web 814 which helps stabilize the cross section of the blade during service.

The blade shells generally consist of one or more reinforcing layers 816 and may include core materials 818 between the reinforcing layers for increased stiffness.

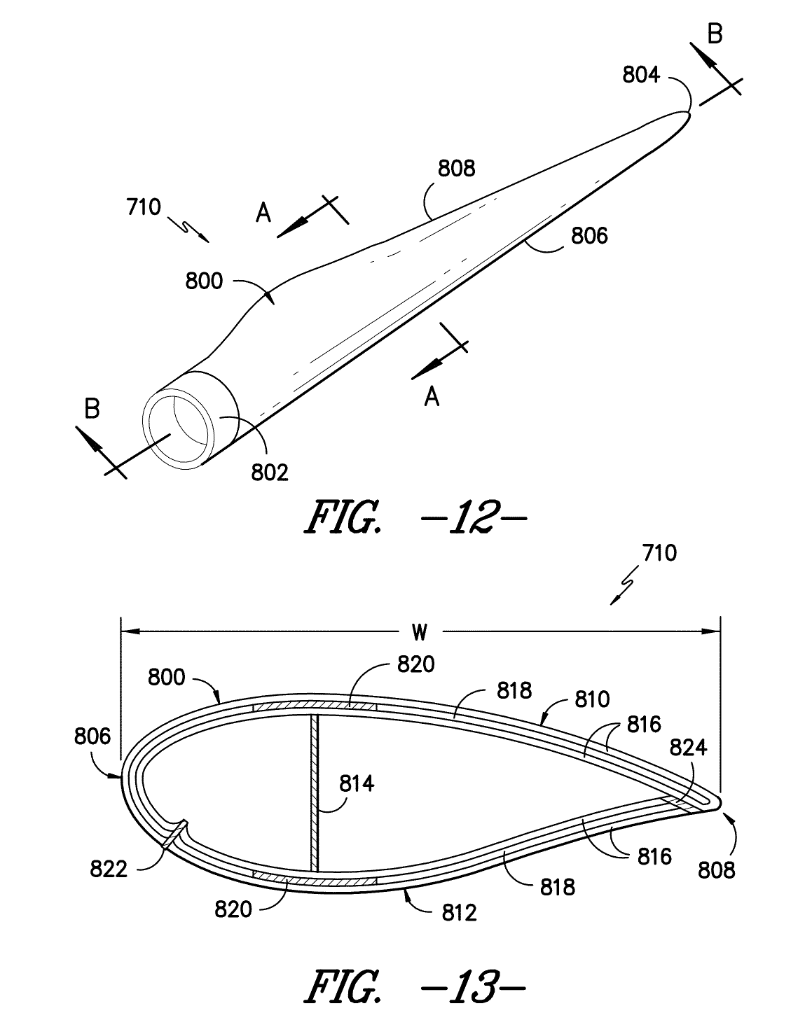

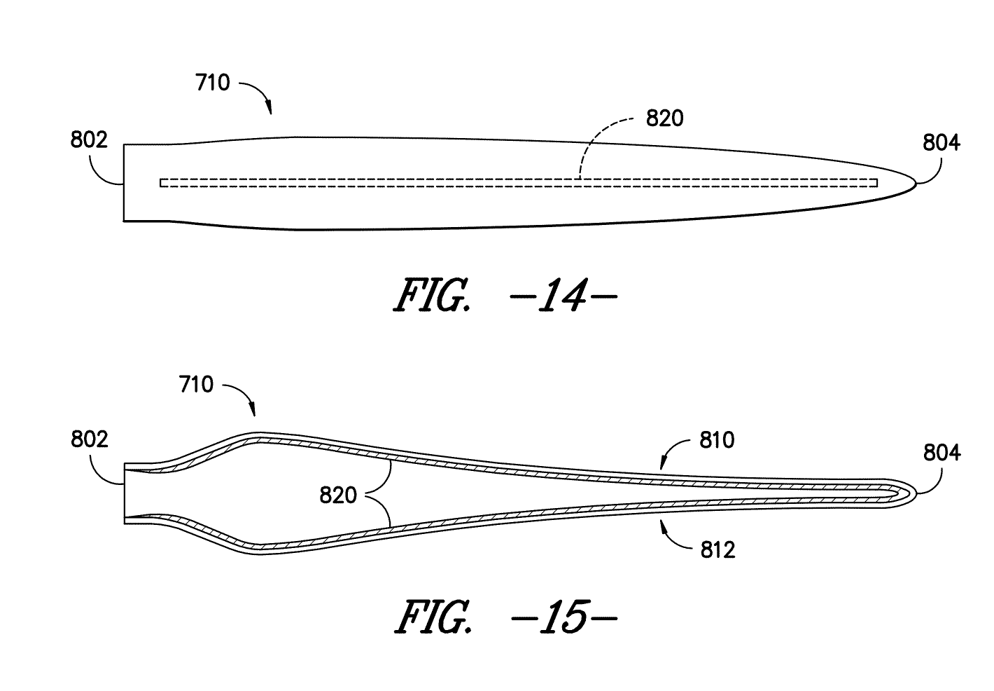

FIG. 13 also identifies two primary structural elements or spar caps 820 located within both the pressure side and suction side shell regions which both extend along the longitudinal axis of the blade as shown in FIGS. 14 and 15. FIG. 14 represents a plan view of a blade as viewed from either the pressure side or suction side of the blade while FIG. 15 is the sectional view B-B as illustrated in FIG. 12. FIG. 13 also identifies a leading edge spar 822 structural element within the leading edge region, and an additional trailing edge spar 824 structural element within the trailing edge region. FIG. 16 is a view along the length of the blade showing a piece of the blade shell with various layers.

During the wind turbine blade design process, different sections of the structure are optimized based on the most critical design criteria for that section. For example, in blades using fiberglass reinforced spar caps, the size of the spar caps can be based on the stiffness requirements to avoid hitting the turbine tower or the fatigue requirements over which the spar cap can be expected to remain intact over hundreds of millions of load cycles. The nature of the design process and the requirements imposed on the various sections of the blade can benefit from materials which offer the opportunity to be deployed locally within that section. A spar cap reinforcement material with improved fatigue resistance could allow more optimized wind turbine blades when fatigue performance dictates the size and weight of the spar caps.

The agglomerated particle cloud network coated fiber bundle may be formed by any suitable manufacturing method. One method to form the agglomerated particle cloud network coated fiber bundle begins with forming the bundle of fibers. The bundle of fibers contains a plurality of fibers and void space between the fibers. Each fiber contains a surface and the distance between adjacent fibers is defined as the separation distance. The bundle of fibers is coated with a nanoparticle solution, where the nanoparticle solution contains a solvent and a plurality of well dispersed nanoparticles. Typically the nanoparticle dispersion is stable longer than the processing time scale. Preferably the dispersion is stable for at least several days.

The solvent may be an aqueous or non-aqueous solvent. Preferably, the solvent is aqueous because of the cost and environmental concerns, possible wettability of the fiber, ability to create a stable dispersion of particles, and flammability issues. The nanoparticle solution may also contain a film-former or binder. Having a film-former or binder in the nanoparticle solution may be advantageous because the film-former or binder may help to maintain the coating structure during handling, transportation, and storage. The nanoparticle solution may also contain surfactants, stabilizing agents, wetting agents, foaming agents, defoamers, and other processing aids. Surfactants in the nanoparticle solution may be advantageous because the nanoparticles can be dispersed easier and are more stable in the presence of surfactants than in dispersions without surfactants.

In one embodiment, the nanoparticle solution contains at least about 0.5% by weight nanoparticles, more preferably at least about 1% by weight, more preferably at least about 3% by weight. In another embodiment, the nanoparticle solution contains between about 3 and 10% by weight nanoparticles. In another embodiment, the add-on weight of nanoparticles after solvent removal is between 0.7% and 5% by weight of the bundle of fibers. After coating the bundle of fibers (but before drying), the bundle of fibers may be optionally passed through a nip roller. The nip roller may push the nanoparticle solution further into the bundles, while also squeezing the excess liquid out. When the fibers 110 are fiberglass, the nip may optionally be padded with rubber, wool or other material with a Shore hardness less than that of glass to reduce breakage of the glass fibers. The pressure in the nip is controlled to remove excess fluid from the fiber bundles without significantly reducing the tensile strength of the fabric.

After coating the bundle of fibers, the coated bundle of fibers is dried at a temperature above room temperature forming an agglomerated particle cloud network coated fiber bundle. The drying process has been shown to impact the formation of the agglomerated particle cloud network structure. Drying parameters including drying temperature, drying time, air flow rate, fiber bundle tension, and contact pressure during drying may all affect the resulting structure. How the coated fibers are dried (in addition to other processing and material considerations) affects how much the nanoparticles agglomerate and if an agglomerated nanoparticle cloud network or alternative structure is formed. In addition to the agglomerated cloud network formed after drying, the nanoparticles may also form a surface coating on the fiber.

In one embodiment, the coated bundle of fibers is dried at a temperature between about 80 and 150° C. for a time of between about 3 and 60 minutes. In one particular embodiment, the coated bundle of fibers is dried at temperature of 150° C. for 3 minutes. In another embodiment, the surface temperature of fiber bundles immediately after drying is at least 110° C. The energy imparted to the bundle of fibers is sufficient to remove at least 90% of the solvent by weight, preferably at least 99.7% by weight. After drying in one embodiment, the solvent content in the bundle of fibers is preferably less than 1% by weight, more preferably less than about 0.1% by weight.

Mechanical action may also be used during various steps of production. Mechanical action may be used only once in the process, or many times during different steps of the process. Mechanical action may be in the form of sonication, wrapping the bundle of fibers around a roller under tension, moving fabric normal to uniaxial direction in the coating bath, compressing/relaxing fabric, increasing or reducing the tension of the fabric, passing it through a nip, pumping the coating liquor through the fabric, using rollers in the process with surface patterns. These surface patterns can have similar characteristic dimensions to the diameter of the fiber, the outside diameter of the fiber bundle, or the width of the fabric. It has been found that the addition of mechanical action during production of the agglomerated particle cloud network coated fiber bundle may temporarily increase or decrease the space between fibers either once or multiple times, provide a pressure gradient to increase flow of the nanoparticle dispersions into and out of the bundle, and homogenize the distribution of nanoparticles within the bundle. In one embodiment, the bundle of fibers is subjected to mechanical action during the coating step. In another embodiment, the coated bundle of fibers is subjected to mechanical action after the coating step. In another embodiment, the coated bundle of fibers is subjected to mechanical action during the drying step. In another embodiment, the coated bundle of fibers is subjected to mechanical action after the drying step. The mechanical action may help to soften the fabric and create additional discontinuity in the coating by breaking big agglomerated particle into smaller pieces.

Any other alternate coating method may be used including but not limited to powder coating, electrostatic deposition, spray coating, foam coating and the like. In powder coating method, the particles are free-flowing, dry powder. The particles are sprayed to the bundle of fiber. The particles may be further moved into the bundle with the help of vacuum or other mechanical processes. In electrostatic deposition, the dry powder of particles or small droplets of particle solution are charged and then accelerated toward the bundle of fibers by an electric field. The bundle of fiber may be further treated such as heat treatment to fix the coating structure.

After the agglomerated particle cloud network coated fiber bundle is formed, it may be further processed into an agglomerated particle cloud composite using the infusing the agglomerated particle cloud network coated fiber bundle with resin as described previously.

### EXAMPLES

The invention will now be described with reference to the following non-limiting examples, in which all parts and percentages are by weight unless otherwise indicated.

### Fatigue Testing Method

During testing, fatigue loads are normally characterized by an R value which is defined as the ratio of minimum to maximum applied stress. By convention, compressive stress is taken to be a negative number and tension stress is taken as a positive number. Full characterization of fatigue performance involves testing over a range of R values such as R=0.1, −1, and 10, which corresponds to tension-tension, tension-compression, and compression-compression fatigue cycles respectively. Tension-tension fatigue with R=0.1 is a key metric of fatigue performance and was used to quantify the fatigue behavior of composite systems herein.

The fatigue performance of the composite materials made with the coated fiber bundles was measured using a standard tension-tension fatigue test. Dog-bone shaped test specimens were cut from composite panels using CNC cutting equipment, the preferred shape has a prismatic gage section. This feature allowed for easy measurement of strain levels in the gage section via a clip-on extensometer or strain gage.

In preparation for testing, composite tabs were adhesively bonded to the grip areas of the specimen. Optionally, strain gages were bonded to the surface of the gage section of the specimen to measure strain levels. Finally, the specimens were environmentally conditioned for 40 hours at 23° C.+/−3° C. and 50%+/−10% relative humidity.

Using a servohydraulic test machine equipped with hydraulic wedge grips, the specimens were gripped with using the minimum pressure required to avoid slipping. The machine was programmed to load the specimen in sinusoidal fashion using a specified frequency, mean load, and load amplitude. Cyclic loading continued until the specimen failed.

Typical schemes employ testing at a given R value with peak stress values chosen for the different tests of 80%, 60%, 40%, and 20% of the quasi-static strength. Test frequency is chosen to accelerate testing while ensuring the specimen temperature does not increase significantly. This means that lower stress level testing can be done at higher frequencies than higher stress level tests.

The output of a typical fatigue testing regimen at a given R value is known as an S-N curve which relates the number of cycles a material can survive to specified loading conditions. S-N curves provide the most common comparison tool for basic fatigue performance evaluation. S-N curves for well-defined conditions are frequently used to compare the fatigue performance of different composite systems under similar loading. Improvement in R=0.1 fatigue testing, generally indicates a significant change in the fatigue behavior of a composite material.

Wind blades are generally designed to withstand over 10⁸ loading and unloading cycles, however testing materials to such extremes is an impractical exercise. Comparisons are often made among materials at intermediate points such as the one million or 10⁶ cycle performance. In order to screen samples, a specific peak loading level of 1450 N/mm of specimen gage section width was applied and the number of cycles to failure was measured for each sample. This loading was chosen to balance the amount of time required to perform an experiment with the reliability of the data for predicting fatigue performance at more typical levels of strain. The loading level of 1450N/mm was also chosen such that the epoxy control sample would withstand about 10⁵ cycles.

### Sample Layup

The typical laminate used for tensile fatigue screening was [±45/±45/₉₀0/0₉₀]s where the ±45 refers to a ply of ±45° bi-axial E-glass fabric (Devoid AMT DB 810-E05). The ₉₀0 refers to a ply of predominantly 0° unidirectional E-glass fabric with a small quantity of 90° oriented fibers and chopped fibers stitched to one side (Devoid AMT L1200/G50-E07), which was used as received for control samples and coated for other examples. The orientation of the fabric is defined by the order of the terms in the laminate specification. Overall the laminate was symmetric and contained 8 plies of fabric.

The layup procedure was to stack the layers on top of a flat glass tool prepared with a mold release and covered with one layer of release fabric (peel ply). A laser crosshair was used to provide a fixed reference for alignment of the fibers in each layer. First, two layers of ±45 fabric were placed on the tool and aligned so that the fibers ran at a 45° angle to the crosshair. Both pieces of fabric were placed so that the fibers on the top surfaces ran in the same direction. Then a ₉₀0 layer of the unidirectional fabric was aligned with the crosshair and placed with the unidirectional tows up. This was followed with a 0₉₀ layer of unidirectional fabric that was aligned and placed with the unidirectional side down. The next ₉₀0 layer of unidirectional fabric was placed with the unidirectional tows up and a final 0₉₀ layer was placed with the unidirectional tows facing down. The last two layers of ±45 fabric were placed so that the fibers on their top surface ran perpendicular to the fibers on the top surface of the ±45 fabric on the bottom two layers of the fabric stack. Finally, the laminate stack was covered with another layer of release fabric (peel ply).

The vacuum infusion molding process was used to impregnate the laminates with resin. On top of the release fabric for each laminate, a layer of flow media was used to facilitate resin flowing into the reinforcement plies. The entire laminate was covered with a vacuum bagging film which was sealed around the perimeter of the glass mold. Vacuum was applied to the laminate and air was evacuated from the system. Resin was then prepared and pulled into the reinforcement stack under vacuum until complete impregnation occurred. After the resin was cured, the composite panel was removed from the mold and placed in an oven for post-curing.

### Materials

The 0₉₀ and ₉₀0 fabric in the examples refers to Devoid AMT L1200/G50-E07 obtained from PPG. This fabric has a basis weight of 1250 gsm with unidirectional glass fiber bundles about 1150 gsm in the 0° direction (machine direction), 50 gsm fibers in a second direction (cross-machine direction), and 50 gsm chopped fibers stitch bonded to the face containing the fibers in a second direction. The face of this fabric is the exposed unidirectional glass fiber bundles and the back of this fabric is the side containing the chopped fibers.

The ±45 fabric in the following examples refers to as received Devoid AMT DB 810-E05 obtained from PPG.

The cationic fumed silica refers to CAB-O-SPERSE PG-022 from Cabot Corporation. It is an aqueous dispersion of cationic fumed silica particles with a mean particle diameter of less than 0.2 μm as specified by Cabot Corporation. As received it contains about 20% by weight of dispersed fumed silica nanoparticles. When diluted with water and stored at room temperature, the dispersions are stable for more than 1 day.

### Control Example 1

An unsaturated polyester control sample was made using the sample layup procedure using the 0₉₀ fabric and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width measured a lifetime of approximately 1×10⁴ cycles.

### Control Example 2

An epoxy control sample was made using the sample layup procedure using the 0₉₀ fabric and the ±45 fabric. The stacked textiles were infused in a standard vacuum infusion apparatus at a vacuum of less than 50 mbar with 76.92% wt epoxy resin (EPIKOTE™ Resin MGS® RIMR 135 available from Momentive), 18.46% curing agent (EPIKURE™ Curing Agent MGS® RIMH 137 available from Momentive) and 4.62% wt curing agent (EPIKURE™ Curing Agent MGS® RIMH 134 available from Momentive). The resin flow direction was along the 0° direction of the 0₉₀ fabric. The panel was cured at room temperature more than 16 hours and further post cured at 80° C. for 24 hours. Fatigue testing of the unmodified glass reinforced epoxy resin composite at R=0.1 with a load of 1450 N/mm of specimen gage section width measured a lifetime of approximately 1×10⁵ cycles.

### Example 1

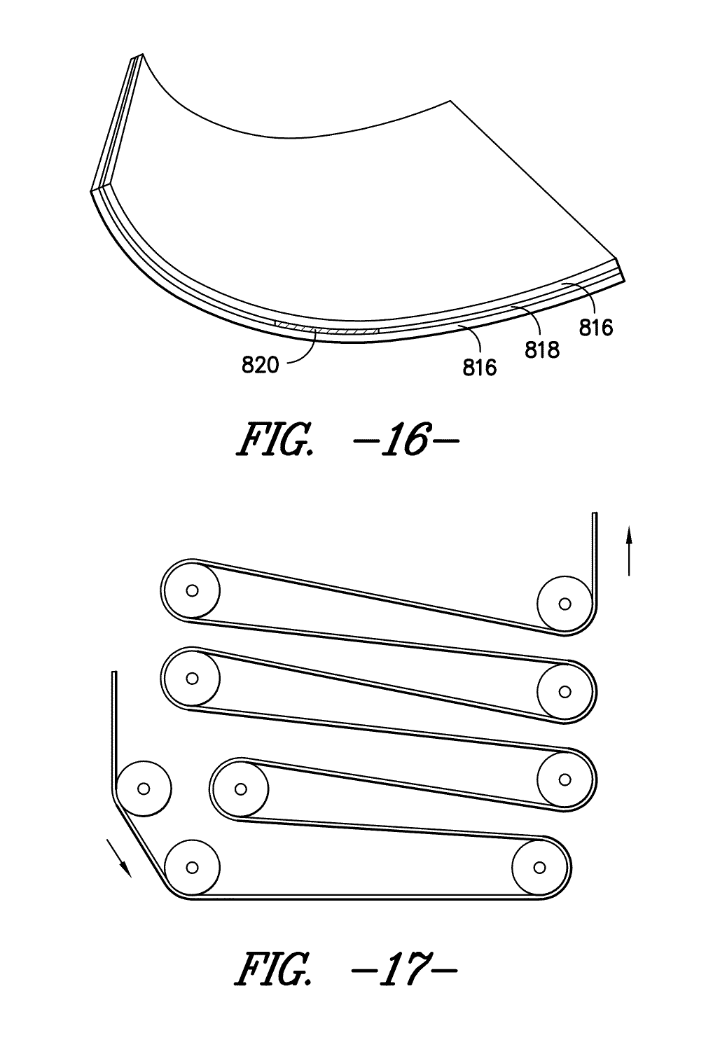

An agglomerated particle cloud network coated fiber bundle was formed by coating the 0₉₀ fabric with a dispersion of cationic fumed silica diluted to a 5% by weight concentration in water. The coating was conducted at room temperature and the textile was under tension in the machine direction and subjected to sonication and wrapping and travelling around 9 guide bars as shown in FIG. 17. The fabric bending angle after each guide bar was 21.95° to the face, 68.05° to the face, 176, 15° to the face, 184.75° to the back, 184.70° to the face, 183.56° to the back, 183.56° to the face, 183.56° to the back, 97.07° to the face. After the guide bars, the textile traveled through a nip roller at a pressure of about 20,000 N/m and was dried at 150° C. for 3 minutes. This formed the agglomerated particle cloud network coated fiber bundle.

An SEM of the agglomerated particle cloud network coated fiber bundle is shown in FIG. 2 shows the presence of the agglomerated particle cloud network on the bundle of fibers. One can see from the SEM image the agglomerates of nanoparticles, the bridging between adjacent fibers, and the discontinuous nature of the aggregates on the surface of the fibers.

### Example 2

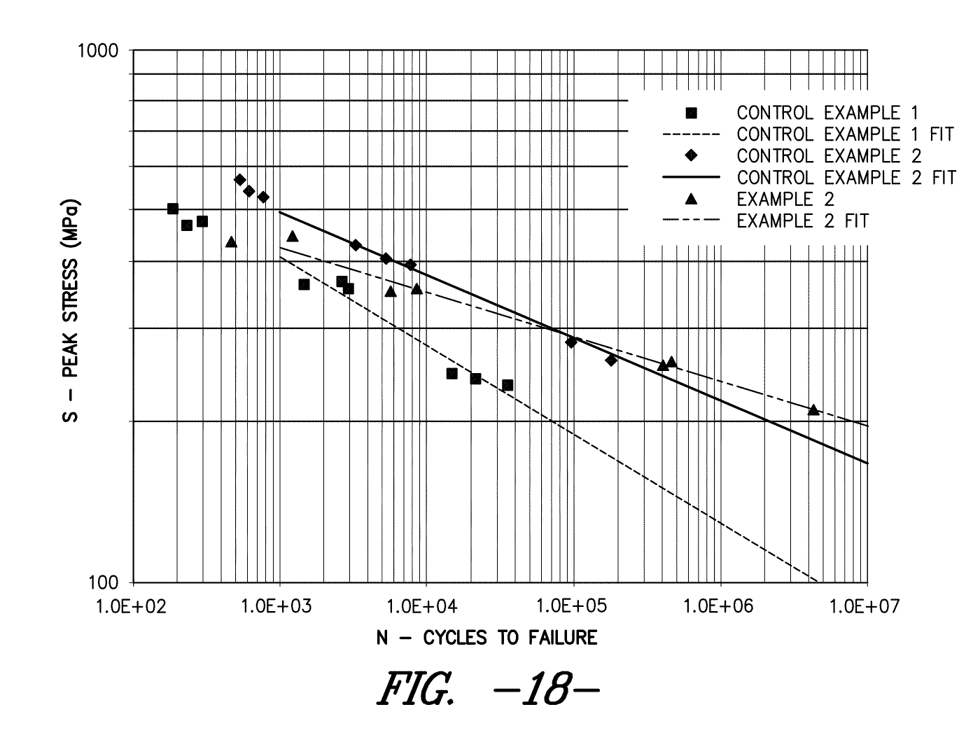

An unsaturated polyester control test sample was made using the sample layup procedure using the coated 0₉₀ fabric from example 1 and the ±45 fabric stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width measured a lift time approximately 50 times that of the Control Example 1. The fiber weight fraction in this composite was about 73-74%. FIG. 18 illustrates an S-N curve comparing the R=0.1 fatigue performance across a range of peak stress values for Control Example 1, Control Example 2, and Example 2. Note that the slope of the S-N curve for Example 2 is preferred over that of both control examples. This performance level offers the possibility of replacing epoxy resin with unsaturated polyester resin in fatigue driven designs.

An SEM of the agglomerated particle cloud network composite is shown in FIG. 4A and shows the presence of the agglomerated particle cloud network on the bundle of fibers. One can see from the SEM image the agglomerates of nanoparticles, the bridging between adjacent fibers, and the discontinuous nature of the aggregates on the around the cross-section of the fibers.

### Example 3

An agglomerated particle cloud network coated fiber bundle was formed by coating the 0₉₀ fabric with a dispersion of cationic fumed silica diluted to a 5% by weight concentration in water. The coating was conducted at room temperature and the textile was under tension in the machine direction and subjected to sonication and wrapping and travelling around 3 guide bars. The fabric bending angle after each guide bar was 21.95° to the face, 68.05° to the face, 90° to the face. After the guide bars, the textile traveled through a nip roller at a pressure of about 20,000 N/m and was dried at 150° C. for 3 minutes. This formed the agglomerated particle cloud network coated fiber bundle.

An SEM of the agglomerated particle cloud network coated fiber bundle is shown in FIG. 19 and shows the presence of the agglomerated particle cloud network on the bundle of fibers. One can see from the SEM image the agglomerates of nanoparticles, the bridging between adjacent fibers, and the discontinuous nature of the aggregates on the surface of the fibers.

### Example 4

An unsaturated polyester control test sample was made using the sample layup procedure using the coated 0₉₀ fabric from example 3 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime approximately 13 times that of the Control Example 1.

### Example 5

An agglomerated particle cloud network coated fiber bundle was formed by coating the 0₉₀ fabric with a dispersion of cationic fumed silica diluted to a 5% by weight concentration in water. The coating was conducted at room temperature and the textile was under tension in the machine direction and wrapping and travelling around 9 guide bars according the setup mentioned in Example 1 without any sonication treatment. After the guide bars, the textile traveled through a nip roller at a pressure of about 20,000 N/m and was dried at 150° C. for 3 minutes. This formed the agglomerated particle cloud network coated fiber bundle.

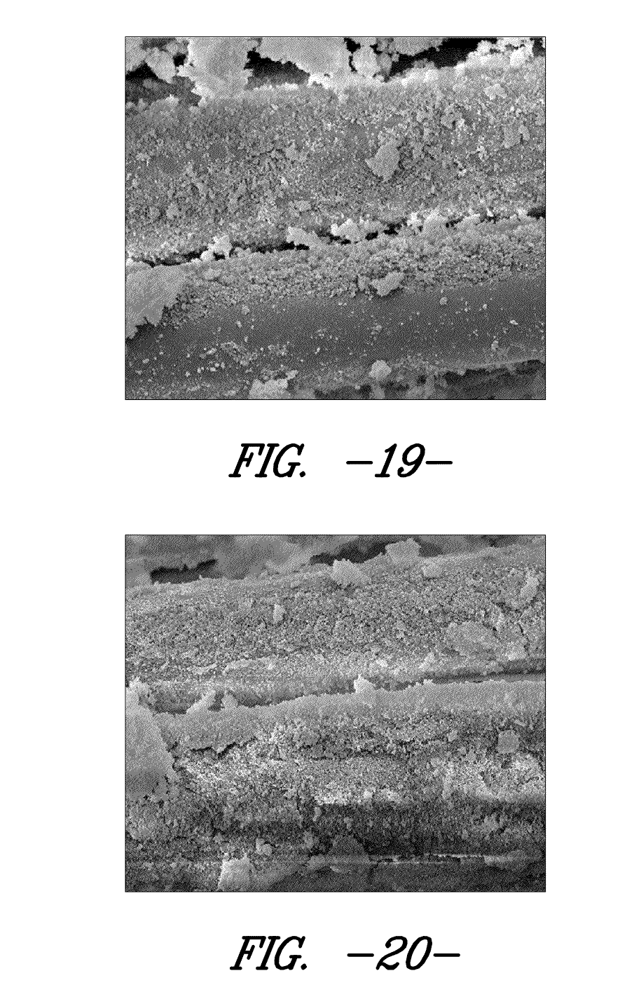

An SEM of the agglomerated particle cloud network coated fiber bundle is shown in FIG. 20 and shows the presence of the agglomerated particle cloud network on the bundle of fibers. One can see from the SEM image the agglomerates of nanoparticles, the bridging between adjacent fibers, and the discontinuous nature of the aggregates on the surface of the fibers.

### Example 6

An unsaturated polyester test sample was made using the sample layup procedure using the coated 0₉₀ fabric from example 5 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime approximately 37 times that of the Control Example 1.

### Example 7

An agglomerated particle cloud network coated fiber bundle was formed by coating the 0₉₀ fabric with a dispersion of cationic fumed diluted to a 5% by weight concentration in water. The coating was conducted at room temperature and the textile was under tension in the machine direction and travelling around 3 guide bars according the setup mentioned in example 3 without any sonication treatment. After the guide bars, the textile traveled through a nip roller at 20,000 N/m and was dried at 150° C. for 3 minutes. This formed the agglomerated particle cloud network coated fiber bundle.

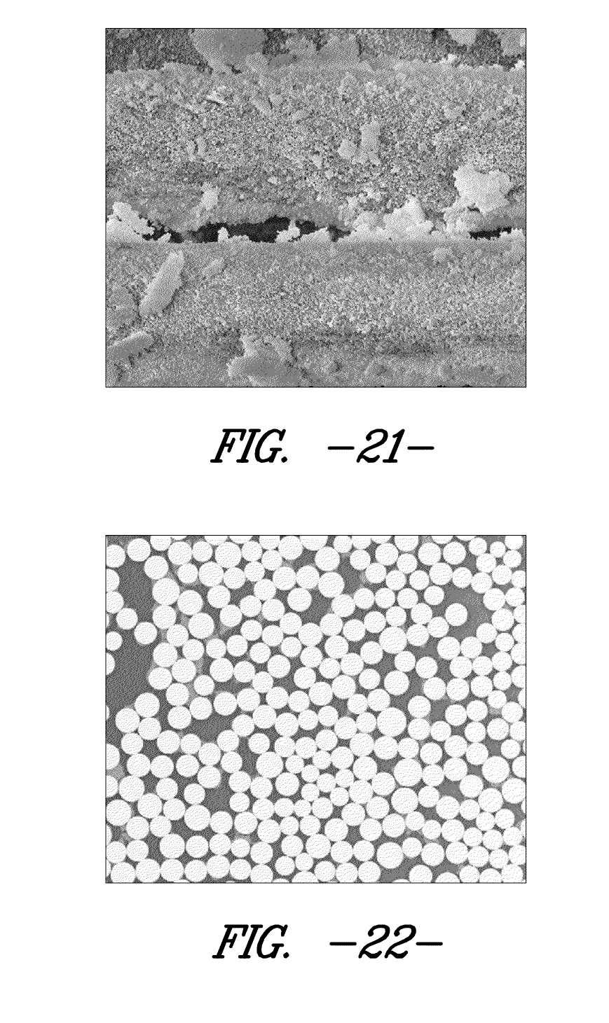

An SEM of the agglomerated particle cloud network coated fiber bundle is shown in FIG. 21 and shows the presence of the agglomerated particle cloud network on the bundle of fibers. One can see from the SEM image the agglomerates of nanoparticles, the bridging between adjacent fibers, and the discontinuous nature of the aggregates on the surface of the fibers.

### Example 8

An unsaturated polyester test sample was made using the sample layup procedure using the coated 0₉₀ fabric from example 7 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime approximately 10 times that of the Control Example 1.

The fiber weight faction of the composite was about 74-75%. An SEM of the agglomerated particle cloud network composite is shown in FIG. 22 and shows the presence of the agglomerated particle cloud network on the bundle of fibers. One can see from the SEM image the agglomerates of nanoparticles, the bridging between adjacent fibers, and the discontinuous nature of the aggregates on the around the cross-section of the fibers.

Examples 1-8 illustrated how the coating processing conditions may affect the coating structure and mechanical performance. More mechanical action (guide bars and sonication treatment) may open up the fiber spacing “d” locally and help facilitate the penetration of the coating solution into the voids in the fiber bundle more effectively.

### Example 9

A silica coated fiber bundle was formed by coating the 0₉₀ fabric with a dispersion of cationic fumed silica diluted to a 0.2% by weight concentration in water. The coating was conducted at room temperature and the textile was under tension in the machine direction and traveled through a nip roller at 20,000 N/m and was dried at 150° C. for 10 minutes.

### Example 10

An unsaturated polyester test sample was made using the sample layup procedure using the coated 0₉₀ fabric from example 9 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime approximately 1.6 times that of the Control Example 1.

### Example 11

A silica coated fiber bundle was formed by coating the 0₉₀ fabric with a dispersion of cationic fumed silica diluted to a 0.5% by weight concentration in water. The coating was conducted at room temperature and the textile was under tension in the machine direction and traveled through a nip roller at 20,000 N/m and was dried at 150° C. for 10 minutes.

### Example 12

An unsaturated polyester test sample was made using the sample layup procedure using the coated 0₉₀ fabric from example 11 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime approximately 2.3 times that of the Control Example 1.

### Example 13

A silica particle coated fiber bundle was formed by coating the 0₉₀ fabric with a dispersion of cationic fumed silica diluted to a 1% by weight concentration in water. The coating was conducted at room temperature and the textile was under tension in the machine direction and subjected to sonication and wrapping and travelling around 9 guide bars according the setup mentioned in example 1. After the guide bars, the textile traveled through a nip roller at 20,000 N/m and was dried at 150° C. for 3 minutes. This formed the silica particle coated fiber bundle.

### Example 14

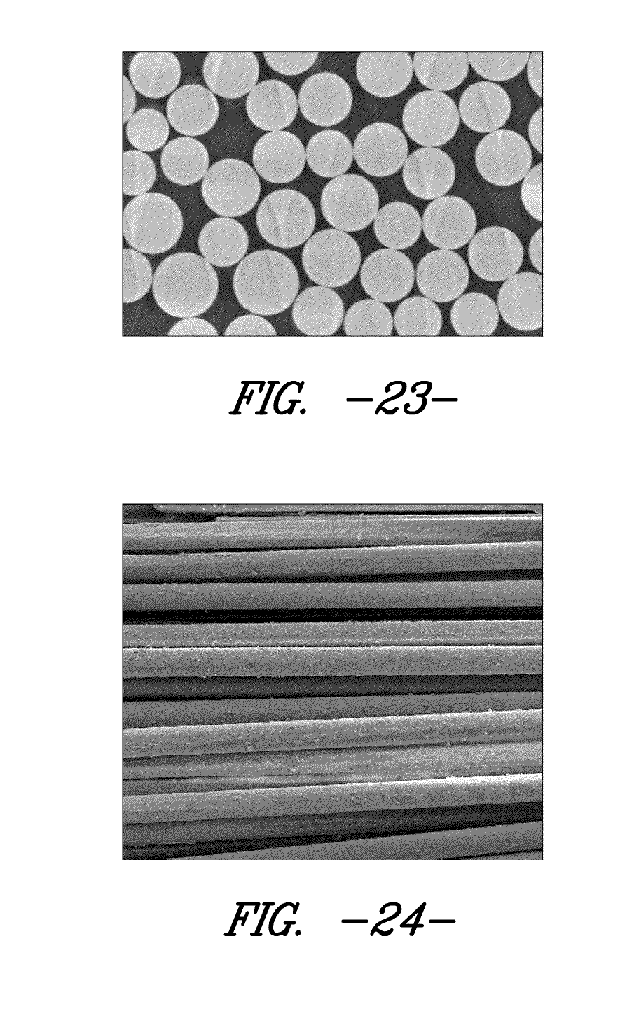

An unsaturated polyester test sample was made using the sample layup procedure using the coated 0₉₀ fabric from example 13 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime approximately 3.6 times that of the Control Example 1 The fiber weight faction of the composite was about 74-75%. A SEM image of the cross-section of the composite is shown in FIG. 23 and shows the lack of presence of the agglomerated particle cloud network on the bundle of fibers. One could see from the SEM image that only a few small agglomerates of nanoparticles exist in the bundle.

### Example 15

A silica coated fiber bundle was formed by coating the 0₉₀ fabric with a dispersion of cationic fumed silica that was diluted to a 1% by weight concentration in water. The coating was conducted at room temperature and the textile was under tension in the machine direction and travelling around 3 guide bars according the setup mentioned in example 3 without any sonication treatment. After the guide bars, the textile traveled through a nip roller at 20,000 N/m and was dried at 150° C. for 3 minutes.

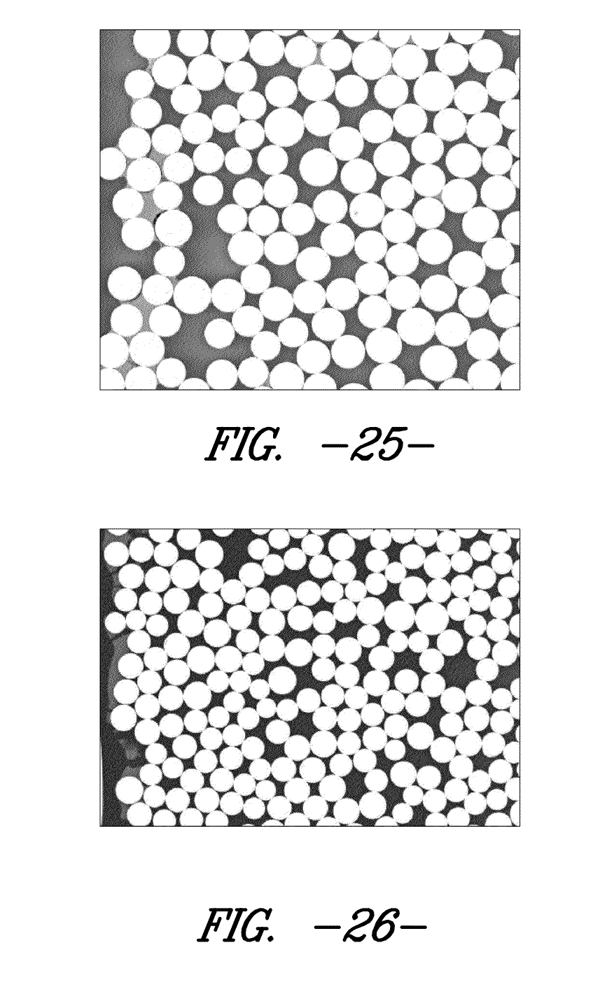

An SEM of the silica coated fibers is shown in FIG. 24. One can see from the SEM image that particles only coated the surface of fibers and a lack of agglomerates particle cloud network in the composite.

### Example 16

An unsaturated polyester test sample was made using the sample layup procedure using the coated 0₉₀ fabric from example 15 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime was approximately 4.1 times that of the Control Example 1.

### Example 17

An agglomerated particle cloud network coated fiber bundle was formed by coating the 0₉₀ fabric with a dispersion of cationic fumed silica that was diluted to a 3% by weight concentration in water. The coating was conducted at room temperature and the textile was under tension in the machine direction and traveled through a nip roller at 20,000 N/m and was dried at 150° C. for 10 minutes. This formed the agglomerated particle cloud network coated fiber bundle.

### Example 18

An unsaturated polyester test sample was made using the sample layup procedure using the coated 0₉₀ fabric from example 17 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime was approximately 16.4 times that of the Control Example 1.

### Example 19

An agglomerated particle cloud network coated fiber bundle was formed by coating the 0₉₀ fabric with a dispersion of cationic fumed silica that was diluted to a 5% by weight concentration in water. The coating was conducted at room temperature and the textile was under tension in the machine direction and traveled through a nip roller at 20,000 N/m and was dried at 150° C. for 10 minutes. This formed the agglomerated particle cloud network coated fiber bundle.

### Example 20

An unsaturated polyester test sample was made using the sample layup procedure using the coated 0₉₀ fabric from example 19 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime was approximately 14.5 times that of the Control Example 1.

### Example 21

An agglomerated particle cloud network coated fiber bundle was formed by coating the 0₉₀ fabric with a dispersion of cationic fumed silica that was diluted to a 10% by weight concentration in water. The coating was conducted at room temperature and the textile was under tension in the machine direction and traveled through a nip roller at 20,000 N/m and was dried at 150° C. for 10 minutes. This formed the agglomerated particle cloud network coated fiber bundle.

### Example 22

An unsaturated polyester test sample was made using the sample layup procedure using the coated 0₉₀ fabric from example 21 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime approximately 29 times that of the Control Example 1.

### Example 23

An agglomerated particle cloud network coated fiber bundle was formed by coating the 0₉₀ fabric with a dispersion of as received cationic fumed silica. The coating was conducted at room temperature and the textile was under tension in the machine direction and traveled through a nip roller at 20,000 N/m and was dried at 150° C. for 10 minutes. This formed the agglomerated particle cloud network coated fiber bundle.

### Example 24

An unsaturated polyester test sample was made using the sample layup procedure using the coated 0₉₀ fabric from example 23 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime was approximately 10.7 times that of the Control Example 1. The sample was observed to have some unwetted region indicating that cloud network structure was less porous than the cloud network structures formed with the lower silica coating concentrations.

As one can see in Examples 9-16 showed that when the silica particle concentration in the coating solution was lower than 3% wt, there were little to no bridging between adjacent fibers resulting in a tensile fatigue improvement was less than 4 times of that Control Example 1. Example 17-22 showed that when the silica particle in the coating solution was between 3% and 10%, the agglomerated silica particles formed around 3%˜36% by volume of the bundle of fibers. In this range the agglomerated particles formed an agglomerated particle cloud network having bridges between adjacent fibers. As a result, the tensile fatigue improvement was more than 10 times of that Control Example 1. Example 23-24 showed that for a silica particle concentration of 20% wt, the large amount of agglomerated particles may have formed a less porous structure within the fabric. Thus as a result, the resin could not infuse as well into the fabric and the tensile fatigue improvement was lower than that of Examples 17-22.

### Example 25

An agglomerated particle cloud network coated fiber bundle was formed by coating the 0₉₀ fabric with a dispersion of cationic fumed silica that was diluted to a 5% by weight concentration in water. The coating was conducted at room temperature and the textile was under tension in the machine direction and traveled through a nip roller at 20,000 N/m and was dried at 80° C. for 8 hours. This formed the agglomerated particle cloud network coated fiber bundle.

### Example 26

An epoxy test sample was made using the sample layup procedure using the coated 0₉₀ fabric from example 25 and the ±45 fabric. The stacked textiles were infused in a standard vacuum infusion apparatus at a vacuum of less than 150 mbar with 76.92% wt epoxy resin (EPIKOTE™ Resin MGS® RIMR 135 available from Momentive), 18.46% curing agent (EPIKURE™ Curing Agent MGS® RIMH 137 available from Momentive) and 4.62% wt curing agent (EPIKURE™ Curing Agent MGS® RIMH 134 available from Momentive). The resin flow direction was along the 0° direction of the 0₉₀ fabric. The panel was cured at room temperature for more than 16 hours and further post cured at 80° C. for 24 hours. Fatigue testing of the unmodified glass reinforced unsaturated polyester composite at R=0.1 with a load of 1450 N/mm of specimen gage section width had a lifetime more than 10 times that of the Control Example 2. At 10 times the Control Example 2 performance testing was stopped.

### Example 27

An agglomerated particle cloud network coated fiber bundle was formed by coating the 0₉₀ fabric with a dispersion of cationic fumed silica that was diluted to a 5% by weight concentration in water. The coating was conducted at room temperature and the textile was under tension in the machine direction and traveled through a nip roller at 20,000 N/m and was dried at 80° C. for 8 hours. This formed the agglomerated particle cloud network coated fiber bundle.

### Example 28

An unsaturated polyester test sample was made using the sample layup procedure using the coated 0₉₀ fabric from example 27 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime approximately 9.2 times that of the Control Example 1 The fiber weight faction of the composite was about 73.75%. An SEM of the agglomerated particle cloud network composite is shown in FIG. 25 and shows the presence of the agglomerated particle cloud network on the bundle of fibers. One can see from the SEM image the agglomerates of nanoparticles, the bridging between adjacent fibers, and the discontinuous nature of the aggregates on the around the cross-section of the fibers.

### Example 29

A silica coated fiber bundle was formed by coating the 0₉₀ fabric with a dispersion of as Aerosil 200 from Evonik Industries dispersed to a 5% by weight concentration in water. The silica was stated by the manufacturer to have a specific surface area of 200 m²/g measured by BET method. The nanoparticles were well dispersed and the dispersion was stable for more than one day. The coating was conducted at room temperature and the textile was under tension in the machine direction and traveled through a nip roller at 20,000 N/m and was dried at 80° C. for 8 hours.

### Example 30

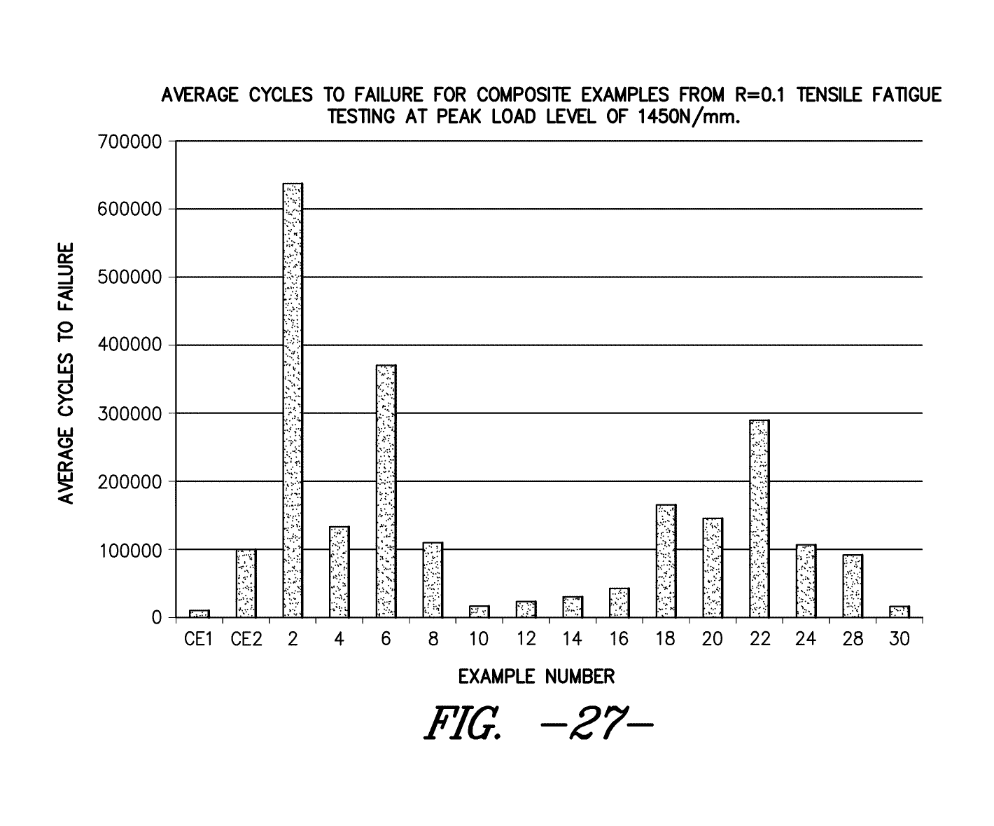

An unsaturated polyester test sample was made using the sample layup procedure using the coated 0₉₀ fabric from example 29 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime approximately 1.6 times that of the Control Example 1. The fiber weight faction of the composite was about 73-74%. An SEM of the cross-section of the composite is shown in FIG. 26 and shows the lack of presence of the agglomerated particle cloud network on the bundle of fibers. One can see from the SEM image that only small amount of the agglomerates of nanoparticles exist on the outer surfaces of the fiber bundle, and very little agglomerates of nanoparticles in the center of the fiber bundle. The bridging was calculated to be less than 5% by number of adjacent fibers in the bundle of fibers. A comparison across many of the examples cited is provided in FIG. 27 which highlights the drastic improvements in fatigue performance imparted by use of the agglomerated particle cloud network coated fiber bundles.

### Example 31

An agglomerated particle cloud network coated fiber bundle was formed by coating the 0₉₀ fabric with a dispersion of cationic fumed silica diluted to a 3% by weight concentration in water. The coating was conducted at room temperature and the textile was under tension in the machine direction and subjected to sonication and wrapping and travelling around 9 guide bars. The fabric bending angle after each guide bar was 180° and alternated on each bar from the face to the back of the fabric (total of five bends to the face and four to the back). After the guide bars, the textile traveled through a nip roller at a pressure of about 50,000 N/m and was dried in contact with steam cans at 130° C. for about 2.3 minutes. This formed the agglomerated particle cloud network coated fiber bundle.

### Example 32

An unsaturated polyester control test sample was made using the sample layup procedure using the coated 0₉₀ fabric from example 31 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime approximately 33 times that of the Control Example 1.

### Example 33

An agglomerated particle cloud network coated fiber bundle was formed by coating the 0₉₀ fabric with a dispersion of cationic fumed silica diluted to a 3% by weight concentration in water. The coating was conducted at room temperature and the textile was under tension in the machine direction and wrapping and travelling around 9 guide bars. The fabric bending angle after each guide bar was 180° and alternated on each bar from the face to the back of the fabric (total of five bends to the face and four to the back). After the guide bars, the textile traveled through a nip roller at a pressure of about 50,000 N/m and was dried in contact with steam cans at 130° C. for about 2.3 minutes. This formed the agglomerated particle cloud network coated fiber bundle.

### Example 34

An unsaturated polyester control test sample was made using the sample layup procedure using the coated 0₉₀ fabric from example 33 and the ±45 fabric. The stacked textiles were infused in a standard vacuum infusion apparatus at a vacuum of less than 50 mbar with 98.52% wt unsaturated polyester resin (Aropol Q67700 available from Ashland) and 1.48% wt methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width had a lifetime approximately 5 times that of the Control Example 1.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An agglomerated particle cloud network coated fiber bundle comprising:
a bundle of fibers comprising a plurality of fibers and void space between the fibers, wherein the fibers comprise a surface, and wherein the distance between adjacent fibers is defined as the separation distance; and,
an agglomerated particle cloud network comprising a plurality of agglomerated nanoparticles, wherein the agglomerated particle cloud network is porous;
wherein the agglomerated nanoparticles are located in at least a portion of the void space in the bundle of fibers, wherein the agglomerated nanoparticles form bridges between at least a portion of the adjacent fibers, wherein between about 10 and 100% by number of fibers contain bridges to one or more adjacent fibers within the agglomerated particle cloud network coated fiber bundle, wherein the agglomerated nanoparticles form between about 1 and 60% of the effective cross-sectional area of the agglomerated particle cloud network coated fiber bundle.

2. The agglomerated particle cloud network coated fiber bundle of claim 1, wherein the average size of the agglomerated nanoparticles is between about 0.25 and 4 times the average separation distance of the fibers.

3. The agglomerated particle cloud network coated fiber bundle of claim 1, wherein the bridges which extend between a portion of the adjacent fibers are adhered to the surface of the fibers.

4. The agglomerated particle cloud network coated fiber bundle of claim 1, wherein the fibers each have a diameter and wherein the majority of bridges are located between two adjacent fibers having a separation distance less than the average diameter of the fibers.

5. The agglomerated particle cloud network coated fiber bundle of claim 1, wherein the bundles of fibers are in a textile selected from the group consisting of a woven, non-woven, knit, and unidirectional textile.

6. The agglomerated particle cloud network coated fiber bundle of claim 1, wherein the fibers comprise a material selected from the group consisting of glass, carbon, boron, silicon carbide, and basalt.

7. The agglomerated particle cloud network coated fiber bundle of claim 1, wherein the nanoparticles comprise a material selected from the group consisting of fumed silica, alumina, colloidal silica, and silica.

8. An agglomerated particle cloud network coated textile comprising the agglomerated particle cloud network coated fiber bundle of claim 1.

9. An agglomerated particle cloud network composite comprising:
a bundle of fibers comprising a plurality of fibers and void space between the fibers, wherein the fibers comprise a surface, and wherein the distance between adjacent fibers is defined as the separation distance;
an agglomerated particle cloud network comprising a plurality of agglomerated nanoparticles, wherein the agglomerated particle cloud network is porous; and,
a resin in at least a portion of the void space in the fiber bundle,
wherein the agglomerated nanoparticles are located in at least a portion of the void space in the bundle of fibers, wherein the agglomerated nanoparticles form bridges between at least a portion of the adjacent fibers, wherein between about 10 and 100% by number of fibers contain bridges to one or more adjacent fibers within the agglomerated particle cloud network coated fiber bundle, wherein the agglomerated nanoparticles form between about 1 and 60% of the effective cross-sectional area of the agglomerated particle cloud network coated fiber bundle.

10. The agglomerated particle cloud network composite of claim 9, wherein the resin is selected from the group consisting of polyester, vinyl ester, epoxy, polyurethane, acrylic, and phenolic resin.

11. The agglomerated particle cloud network composite of claim 9, wherein the average size of the agglomerated nanoparticles is between about 0.25 and 4 times the average separation distance of the fibers.

12. The agglomerated particle cloud network composite of claim 9, wherein the bridges which extend between portions of the adjacent fibers are adhered to the surface of the fibers.

13. The agglomerated particle cloud network composite of claim 9, wherein the majority of bridges are located between two adjacent fibers having a separation distance less than the average diameter of the fibers.

14. The agglomerated particle cloud network composite of claim 9, wherein the bundles of fibers are in a textile selected from the group consisting of a woven, non-woven, knit, and unidirectional textile.

15. The agglomerated particle cloud network composite of claim 9, wherein the fibers comprise a material selected from the group consisting of glass, carbon, boron, silicon carbide, and basalt.

16. The agglomerated particle cloud network composite of claim 9, wherein the nanoparticles comprise a material selected from the group consisting of fumed silica, alumina, colloidal silica, and silica.

17. A structure comprising the agglomerated particle cloud network composite of claim 9.

18. The structure of claim 17, wherein the structure is selected from the group consisting of wind turbine blades, bridges, boat hulls, boat decks, rail cars, pipes, tanks, reinforced truck floors, pilings, fenders, docks, reinforced wood beams, retrofitted concrete structures, aircraft structures, reinforced extrusions and injection moldings.

19. The structure of claim 17, wherein the bridges which extend between portions of the adjacent fibers are adhered to the surface of the fibers.

20. The structure of claim 17, wherein the fibers comprise a material selected from the group consisting of glass, carbon, boron, silicon carbide, and basalt.

21. The structure of claim 17, wherein the nanoparticles comprise a material selected from the group consisting of fumed silica, alumina, colloidal silica, and silica.

22. A wind turbine blade comprising an agglomerated particle cloud network composite in a section of the wind turbine blade selected from the group consisting of spar section, a root section, leading edge, trailing edge, wherein the agglomerated particle cloud network composite comprises:
a bundle of fibers comprising a plurality of fibers and void space between the fibers, wherein the fibers comprise a surface, and wherein the distance between adjacent fibers is defined as the separation distance;
an agglomerated particle cloud network comprising a plurality of agglomerated nanoparticles, wherein the agglomerated particle cloud network is porous; and,
a resin in at least a portion of the void space in the fiber bundle,
wherein the agglomerated nanoparticles are located in at least a portion of the void space in the bundle of fibers, wherein the agglomerated nanoparticles form bridges between at least a portion of the adjacent fibers, wherein between about 10 and 100% by number of fibers contain bridges to one or more adjacent fibers within the agglomerated particle cloud network coated fiber bundle, wherein the agglomerated nanoparticles form between about 1 and 60% of the effective cross-sectional area of the agglomerated particle cloud network coated fiber bundle.

23. The wind turbine blade of claim 22, wherein the agglomerated particle cloud network composite is not located in the wind turbine blade outside the spar section, root section, leading edge, and trailing edge.

24. The wind turbine blade of claim 22, wherein the agglomerated particle cloud network composite is located in the areas of the wind turbine blade subjected to fatigue stresses.
